(19) United States
(12) Patent Application Publication
(10) Pub. No.: US 2025/0203398 A1
(43) Pub. Date: Jun. 19, 2025

(54) INFORMATION CONFIGURATION METHOD AND DEVICE

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 18/847,494

(22) PCT Filed: Mar. 17, 2022
(86) PCT No.: PCT/CN2022/081561

§ 371 Date: Sep. 16, 2024

(51) Int. Cl. H04W 24/02; H04L 5/00; H04W 24/08

(52) U.S. Cl. CPC H04W 24/02; H04L 5/0048; H04W 24/08

(57) ABSTRACT

An information configuration method and a device are provided. The method is performed by a terminal and includes receiving first configuration information sent by a network device. The first configuration information includes a reference signal resource configuration, the reference signal resource configuration includes N channel measurement resource (CMR) resource sets, and each CMR resource set includes at least one CMR resource, where N is a positive integer greater than 0.

### CROSS REFERENCE TO RELATED APPLICATIONS

The present disclosure is the U.S. national phase application of International Application No. PCT/CN2022/081561 filed on Mar. 17, 2022, the content of which is incorporated herein by reference in its entirety for all purposes.

### TECHNICAL FIELD

The present disclosure relates to the field of mobile communication, in particular, to an information configuration method and a device.

### BACKGROUND

In a mobile communication system, a network device can provide services to a terminal through a TRP (Transmission Reception Point), and configure measurement information for the terminal. The measurement information includes CMR (Channel Measurement Resource) for a channel measurement and IMR (Interference Measurement Resource) for an interference measurement. The terminal performs the measurement based on the CMR and IMR configured.

### SUMMARY

According to one aspect of the present disclosure, an information configuration method is provided. The method is performed by a terminal and includes: receiving first configuration information sent by a network device, wherein the first configuration information includes a reference signal resource configuration, the reference signal resource configuration includes N channel measurement resource (CMR) resource sets, and the CMR resource sets include at least one CMR resource, where N is a positive integer greater than 0; and obtaining channel state information by performing a measurement based on the reference signal resource configuration.

According to one aspect of the present disclosure, an information configuration method is provided. The method is performed by a network device and includes: sending first configuration information to a terminal, wherein the first configuration information includes a reference signal resource configuration, the reference signal resource configuration includes N CMR resource sets, and the CMR resource sets include at least one CMR resource, where N is a positive integer greater than 0.

According to one aspect of the present disclosure, an information configuration apparatus is provided. The apparatus includes: a receiving module configured to receive first configuration information sent by a network device, wherein the first configuration information includes a reference signal resource configuration, the reference signal resource configuration includes N CMR resource sets, and the CMR resource sets include at least one CMR resource, where N is a positive integer greater than 0; and an obtaining module configured to obtain channel state information by performing a measurement based on the reference signal resource configuration.

According to one aspect of the present disclosure, an information configuration apparatus is provided. The apparatus includes: a sending module configured to send first configuration information to a terminal, wherein the first configuration information includes a reference signal resource configuration, the reference signal resource configuration includes N CMR resource sets, and the CMR resource sets include at least one CMR resource, where N is a positive integer greater than 0.

According to one aspect of the present disclosure, a terminal is provided. The terminal includes: a processor; a transceiver coupled to the processor; and a memory used to store executable instructions for the processor; wherein the processor is configured to load and execute the executable instructions to implement the information configuration method as described in the above.

According to one aspect of the present disclosure, a network device is provided. The network device includes: a processor; a transceiver coupled to the processor; and a memory used to store executable instructions for the processor; wherein the processor is configured to load and execute the executable instructions to implement the information configuration method as described in the above.

According to one aspect of the present disclosure, a non-transitory computer-readable storage medium is provided, which stores executable program codes thereon, when the executable program codes are loaded and executed by a processor, the information configuration method as described in the above is caused to be implemented.

According to one aspect of the present disclosure, a chip is provided, which includes a programmable logic circuit and/or program instructions, when the chip is run on a terminal or a network device, the information configuration method as described in the above is caused to be implemented.

According to one aspect of the present disclosure, a computer program product is provided, when the computer program product is executed by a processor of a terminal or a network device, the information configuration method as described in the above is caused to be implemented.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 shows a block diagram of a communication system according to embodiments of the present disclosure;

FIG. 2 shows a block diagram of a communication system according to embodiments of the present disclosure;

FIG. 3 shows a block diagram of a communication system according to embodiments of the present disclosure;

FIG. 4 shows a flowchart of an information configuration method according to embodiments of the present disclosure;

FIG. 5 shows a flowchart of a resource determination method according to embodiments of the present disclosure;

FIG. 6 shows a flowchart of a resource determination method according to embodiments of the present disclosure;

FIG. 7 shows a flowchart of a resource determination method according to embodiments of the present disclosure;

FIG. 8 shows a flowchart of a resource determination method according to embodiments of the present disclosure;

FIG. 9 shows a flowchart of a resource determination method according to embodiments of the present disclosure;

FIG. 10 shows a flowchart of a resource determination method according to embodiments of the present disclosure;

FIG. 11 shows a flowchart of a resource determination method according to embodiments of the present disclosure;

FIG. 12 shows a flowchart of an information transmission method according to embodiments of the present disclosure;

FIG. 13 shows a flowchart of an information transmission method according to embodiments of the present disclosure;

FIG. 14 shows a block diagram of an information configuration apparatus according to embodiments of the present disclosure;

FIG. 15 shows a block diagram of an information configuration apparatus according to embodiments of the present disclosure;

FIG. 16 shows a block diagram of an information configuration apparatus according to embodiments of the present disclosure;

FIG. 17 shows a block diagram of an information configuration apparatus according to embodiments of the present disclosure; and

FIG. 18 shows a schematic diagram of a structure of a communication device according to embodiments of the present disclosure.

### DETAILED DESCRIPTION

In order to make the purpose, technical solutions, and advantages of the present disclosure clearer, a further detailed description of embodiments of the present disclosure will be provided in the following in conjunction with the drawings.

A detailed explanation of embodiments will be provided herein, which are illustrated in the drawings. The following description when referring to the drawings, unless otherwise indicated, the same reference numerals in different drawings represent the same or similar elements. The embodiments described in the following do not represent all embodiments consistent with the present disclosure. On the contrary, the embodiments are only examples of devices and methods consistent with some aspects of the present disclosure as detailed in the appended claims.

Terms used in present disclosure are for the purpose of describing specific embodiments only and are not intended to limit the present disclosure. The singular form used in the present disclosure and the appended claims is also intended to include the multiple form, unless the context clearly indicates otherwise. It should also be understood that the term “and/or” used herein refers to and includes any or all possible combinations of one or more related items listed.

It should be understood that although various information may be described using terms such as first, second, and third in present disclosure, such information should not be limited to these terms. These terms are only used to distinguish information of the same type from each other. For example, without departing from the scope of the present disclosure, the first information can also be referred to as the second information, and similarly, the second information can also be referred to as the first information. For example, the word “if” used herein can be interpreted as “when”, or “while”, or “in response to determination”, depending on the context.

It should be noted that the information (including but not limited to user device information, user personal information, etc.), data (including but not limited to data used for analysis, stored data, displayed data, etc.), and signals involved in the present disclosure are all authorized by users or fully authorized by all parties, and the collection, use, and processing of relevant data must comply with relevant laws, regulations, and standards of relevant countries and regions.

An explanation of an application scenario of the present disclosure will be provided in the following.

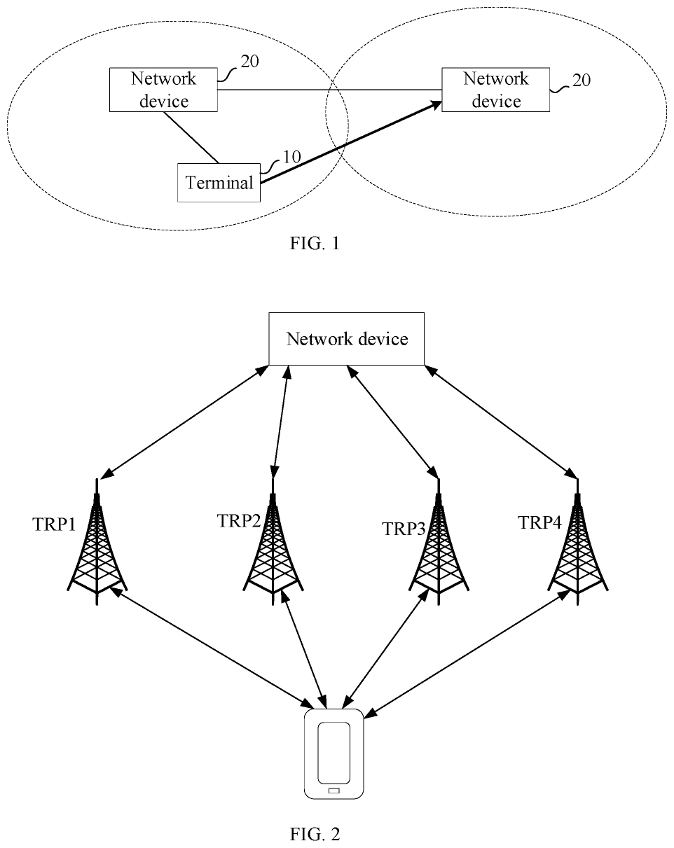

FIG. 1 shows a block diagram of a communication system according to embodiments of the present disclosure. The communication system can include a terminal 10 and a network device 20.

The terminal 10 can be multiple terminals 10. Each cell managed by the network device 20 can have one or more terminals 10 to be distributed therein. The terminal 10 can include various devices with wireless communication capabilities, such as handheld devices, vehicle mounted devices, wearable devices, computing devices or other processing devices connected to the wireless modem, as well as various forms of user equipment (UE), mobile stations (MS), and so on. For the convenience of description, in embodiments of the present disclosure, the devices mentioned above are collectively referred to as terminals.

The network device 20 is a device deployed in the access network to provide wireless communication functionality for the terminal 10. For the convenience of description, in embodiments of the present disclosure, the devices mentioned above that provides wireless communication functionality for the terminal 10 are collectively referred to as network devices. The connection between the network device 20 and the terminal 10 can be established through a radio interface, and the network device 20 and the terminal 10 can communicate through the connection, including signaling and data exchange. The network device 20 can be multiple network devices 20, and adjacent network devices 20 can also communicate with each other through wired or wireless means. The terminal 10 can switch between different network devices 20, that is, the terminal 10 can establish the connection with different network devices 20.

The network device 20 can include various forms of macro base stations, micro base stations, relay stations, access points, and so on. In systems using different wireless access technologies, the names of the devices with network device functionality may vary. For example, in the 5G NR system, the network device is called gNodeB or gNB. With the evolution of the communication technology, the name “network device” may change.

In some embodiments, the network device can include one or more transmission and reception points, or a gNB can include one or more panels (antenna panels).

In some embodiments, as shown in FIG. 2, a network device is configured with four TRPs, namely TRP1, TRP2, TRP3, and TRP4. The network device establishes the communication connection with the terminal through these four TRPs, and can then communicate with the terminal through these four TRPs.

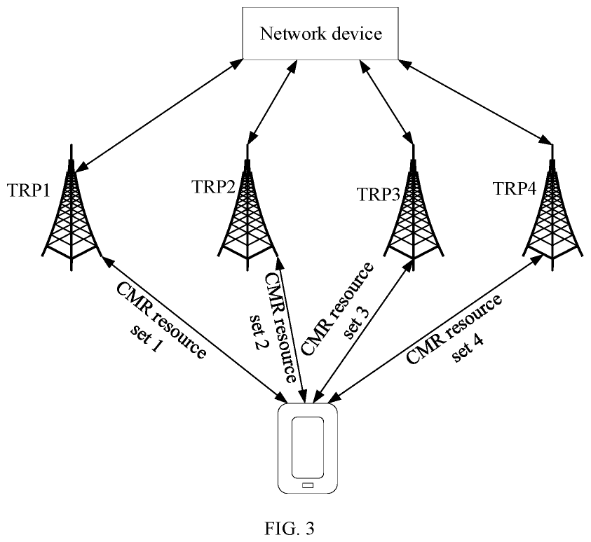

In some embodiments, the network device sends first configuration information to the terminal, and configure in advance multiple CMR resource sets for the terminal based on a reference signal resource configuration included in the first configuration information, so that the terminal can perform channel measurements based on the multiple CMR resource sets. As shown in FIG. 3, each CMR resource set corresponds to one TRP. That is, if the network device is configured with four TRPs, one CMR resource set will be configured for each TRP. For example, TRP1 corresponds to CMR resource set 1, TRP2 corresponds to CMR resource set 2, TRP3 corresponds to CMR resource set 3, and TRP4 corresponds to CMR resource set 4.

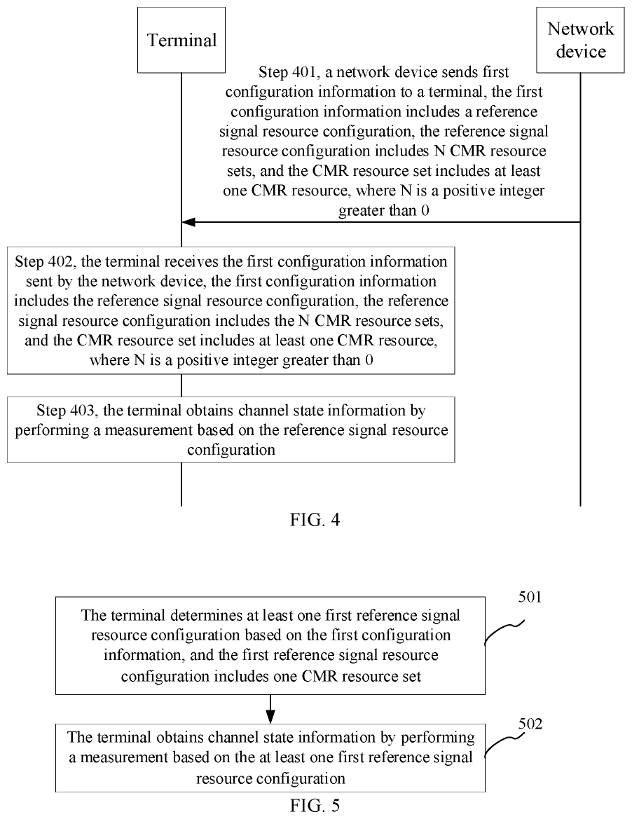

FIG. 4 shows a flowchart of an information configuration method according to embodiments of the present disclosure. The method can be applied to the terminal and the network device as shown in FIG. 1. The method includes at least some of the following steps.

In step 401, a network device sends first configuration information to a terminal. The first configuration information includes a reference signal resource configuration. The reference signal resource configuration includes N CMR resource sets, and the CMR resource set includes at least one CMR resource, where N is a positive integer greater than 0.

In some embodiments of the present disclosure, the network device sends the first configuration information to the terminal, and the first configuration information includes the reference signal resource configuration. The network device configures for the terminal N CMR resource sets based on the reference signal resource configuration, so as to notify the terminal the at least one CMR resource used for the channel measurement, where N is a positive integer greater than 0. In some embodiments, N can be 1, 2, 4, 6, 8 or other values, which is not limited in embodiments of the present disclosure.

In some embodiments, the CMR resource configured for the terminal by the network device is either a CSI-RS (Channel State Information Reference Signal) resource, or an SSB (Synchronization Signal Block) resource.

In some embodiments, the reference signal resource configuration sent by the network device further includes an IMR resource. The IMR resource is used for the interference measurement. In some embodiments, there is a corresponding relationship between the IMR resource and the CMR resource. In some embodiments, one CMR resource corresponds to at least one IMR resource. In some embodiments, at least one CMR resource corresponds to one IRM resource.

In some embodiments, the IMR resource can be Non-Zero-Power Channel State Information Reference Signal, NZP-CSI-RS (Non-Zero-Power CSI-RS) resource or Zero-Power Channel State Information Reference Signal, ZP-CSI-RS (Zero-Power CSI-RS) resource.

In step 402, the terminal receives the first configuration information sent by the network device. The first configuration information includes the reference signal resource configuration. The reference signal resource configuration includes the N CMR resource sets, and the CMR resource set includes at least one CMR resource, where N is a positive integer greater than 0.

In some embodiments, the terminal receives the first configuration information sent by the network device to determine the N CMR resource sets of the reference signal resource configuration included in the first configuration information.

In some embodiments, each CMR resource set corresponds to one TRP. That is, the network device configures N CMR resource sets for the terminal, and the network device will communicate with the terminal through N TRPs. As shown in FIG. 3, the network device is configured with four TRPs, and each TRP corresponds to one CMR resource set.

In some embodiments, the CMR resource set can also be replaced with a CMR resource subset.

In step 403, the terminal obtains channel state information by performing a measurement based on the reference signal resource configuration.

After determining the N CMR resource sets configured by the network device, the terminal can perform the measurement based on the N CMR resource sets, obtain the channel state information, and then report the obtained channel state information to the network device.

It should be noted that steps executed by the network device can form separate embodiments, and steps executed by the terminal can also form separate embodiments. The present disclosure does not limit this.

According to embodiments of the present disclosure, the terminal obtains N CMR resource sets configured by the network device, where N is a positive integer greater than 0. The terminal performs the channel measurement based on the N CMR resource sets, and obtains the channel state information through the measurement. The present disclosure provides a resource configuration method that supports more CMR resource sets, thereby expanding the channel measurement method and improving the transmission efficiency.

Based on embodiments shown in FIG. 4, the terminal can determine different types of reference signal resource configurations based on the reference signal resource configuration by the network device. FIG. 5 shows a flowchart of a resource determination method according to embodiments of the present disclosure. As shown in FIG. 5, the method includes following steps.

In step 501, the terminal determines at least one first reference signal resource configuration based on the first configuration information, and each of the at least one first reference signal resource configuration includes one CMR resource set.

In some embodiments of the present disclosure, after receiving the reference signal resource configuration configured by the network device, the terminal can obtain N CMR resource sets, and determine at least one first reference signal resource configuration, each of which includes one CMR resource set.

In some embodiments, the first reference signal resource configuration is explicitly configured by the network device. That is, the network device directly configures the first reference signal resource configuration. In some embodiments, the first reference signal resource configuration configured by the network device includes one CMR resource set, and the CMR resource set includes four CMR resources, namely CMR resource 1, CMR resource 2, CMR resource 3, and CMR resource 4.

In some embodiments, the CMR resource sets included in any two first reference signal resource configurations out of multiple first reference signal resource configurations include the same CMR resources.

According to embodiments of the present disclosure, the terminal can determine multiple first reference signal resource configurations, each first reference signal resource configuration includes one CMR resource set, and the CMR resource set included in each first reference signal resource configuration is the same. That is, the multiple first reference signal resource configurations determined by the terminal correspond to the same TPR, and the CMR resource sets corresponding to the multiple first reference signal resource configurations are all used to measure the reference signal for the same TRP.

In some embodiments, the terminal determines two first reference signal resource configurations, namely the first reference signal resource configuration #1 and the first reference signal resource configuration #2, and the CMR resource sets included in first reference signal resource configuration #1 and the first reference signal resource configuration #2 are the same, which means that the CMR resource included in each CMR resource set is the same.

In some embodiments, any two first reference signal resource configurations include different IMRs. In some embodiments, any two first reference signal resource configurations determined by the terminal include the same CMR resource sets, while any two first reference signal resource configurations include different IMRs, and different IMRs correspond to different TRP interferences.

In some embodiments, IMR #1 corresponds to interferences from TRP #2, TRP #3, and TRP #4, and IMR #2 corresponds to an interference from TRP #2.

In some embodiments, explanations will be provided, taking that the network device configures four CMR resource sets for the terminal, and each CMR resource set corresponds to one TRP as an example. In the case as mentioned above, the first reference signal resource configuration determined by the terminal includes at least one of the following cases:
first reference signal resource configuration #1: CMR resource set #1, and IMR #1 that corresponds to interferences from TRP #2, TRP #3, and TRP #4;
first reference signal resource configuration #2: CMR resource set #1, and IMR #2 that corresponds to an interference from TRP #2;
first reference signal resource configuration #3: CMR resource set #1, and IMR #3 that corresponds to an interference from TRP #3;
first reference signal resource configuration #4: CMR resource set #1, and IMR #4 that corresponds to an interference from TRP #4;
first reference signal resource configuration #5: CMR resource set #1, and IMR #5 that corresponds to interferences from TRP #2 and TRP #3;
first reference signal resource configuration #6: CMR resource set #1, and IMR #6 that corresponds to interferences from TRP #2 and TRP #4;
first reference signal resource configuration #7: CMR resource set #1, and IMR #7 that corresponds to interferences from TRP #3 and TRP #4.

It should be noted that in the above embodiments, that one first reference signal resource configuration corresponds to one IMR resource is taken an example, while in some embodiments, one first reference signal resource configuration can correspond to multiple IMR resources.

For example, that one first reference signal resource configuration corresponds to multiple IMR resources includes at least one of the following cases:
first reference signal resource configuration #1: CMR resource set #1, IMR #1 that corresponds to interferences from TRP #2, TRP #3, and TRP #4, and IMR #2 that corresponds to an interference from TRP #2;
first reference signal resource configuration #2: CMR resource set #1, IMR #3 that corresponds to an interference from TRP #3, IMR #4 that corresponds to an interference from TRP #4, and IMR #5 that corresponds to interferences from TRP #2 and TRP #3;
first reference signal resource configuration #3: CMR resource set #1, IMR #6 that corresponds to interferences from TRP #2 and TRP #4, and IMR #7 that corresponds to interferences from TRP #3 and TRP #4.

It should be noted that if the first reference signal resource configuration includes all cases of IMRs, then that any two first reference signal resource configurations include the same CMR resource sets will not occur. In addition, embodiments of the present disclosure are only explained based on that TRP #2, TRP #3, and TRP #4 impose interferences on TRP #1 as an example. In some embodiments, in addition to the interferences from TRP #2, TRP #3, and TRP #4, there are also other TRPs that impose interferences, which will not be enumerated in embodiments of the present disclosure.

In some embodiments, in the CMR resource sets included in any two first reference signal resource configurations, there is at least one different CMR resource.

In some embodiments of the present disclosure, the terminal can determine multiple first reference signal resource configurations, each first reference signal resource configuration includes one CMR resource set, and the CMR resource set included in each first reference signal resource configuration is not the same. That is, the multiple first reference signal resource configurations determined by the terminal correspond to different TPRs, and the CMR resource sets corresponding to the multiple first reference signal resource configurations are used to measure reference signals for different TRPs.

In some embodiments, that any two first reference signal resource configurations include different CMR resource sets means that there is at least one different CMR resource between any two CMR resource sets. That is, these CMR resource sets correspond to different TRPs.

In some embodiments, if the terminal determines two first reference signal resource configurations, namely first reference signal resource configuration #1 and first reference signal resource configuration #2, and the CMR resource sets included in the first reference signal resource configuration #1 and the first reference signal resource configuration #2 are not the same CMR resource sets. The CMR resource set in the first reference signal resource configuration #1 includes CMR resource #1, CMR resource #2, CMR resource #3, and CMR resource #4. The CMR resource set in the first reference signal resource configuration #2 includes CMR resource #1, CMR resource #2, CMR resource #4, and CMR resource #5. The CMR resource #3 and the CMR resource #5 are different CMR resources, and thus it indicates that the CMR resource sets in the first reference signal resource configuration #1 and the first reference signal resource configuration #2 are different.

In some embodiments, the IMRs included in any two first reference signal resource configurations can be different, or the IMRs included in any two first reference signal resource configurations can be the same. In some embodiments of the present disclosure, any two first reference signal resource configurations determined by the terminal include different CMR resource sets, and any two first reference signal resource configurations include different IMRs, or any two first reference signal resource configurations include the same IMR.

In some embodiments, the first reference signal resource configuration #1 includes CMR resource set #1, and IMR #1 that corresponds to interferences from TRP #3 and TRP #4, and the first reference signal resource configuration #2 includes CMR resource set #2, and IMR #1 that corresponds to interferences from TRP #3 and TRP #4. That is, the first reference signal resource configuration #1 and the first reference signal resource configuration #2 include different CMR resource sets, which means that the reference signals for different TRPs are used as channel measurement resources, but the first reference signal resource configuration #1 and the first reference signal resource configuration #2 include the same IMR.

In some embodiments, the first reference signal resource configuration #1 includes CMR resource set #1, and IMR #1 that corresponds to interferences from TRP #2, TRP #3, and TRP #4, and the first reference signal resource configuration #2 includes CMR resource set #2, and IMR #2 that corresponds to interferences from TRP #3 and TRP #4. That is, the first reference signal resource configuration #1 and the first reference signal resource configuration #2 include different CMR resource sets, which means that the reference signals for different TRPs are used as channel measurement resources, and the first reference signal resource configuration #1 and the first reference signal resource configuration #2 also include different IMRs.

Explanations will be provided in the following, taking that the network device configures four CMR resource sets for the terminal, and each CMR resource set corresponds to one TRP as an example. In the case as mentioned above, the first reference signal resource configuration determined by the terminal includes at least one of the following cases:
first reference signal resource configuration #1: CMR resource set #1, IMR #1 that corresponds to interferences from TRP #2, TRP #3, and TRP #4, and IMR #2 that corresponds to an interference from TRP #2;
first reference signal resource configuration #2: CMR resource set #2, and IMR #3 that corresponds to an interference from TRP #3;
first reference signal resource configuration #3: CMR resource set #3, and IMR #4 that corresponds to an interference from TRP #4;
first reference signal resource configuration #4: CMR resource set #4, IMR #5 that corresponds to interferences from TRP #2 and TRP #3, IMR #6 that corresponds to an interference from TRP #2, and IMR #7 that corresponds to an interference from TRP #3.

In step 502, the terminal obtains channel state information by performing a measurement based on the at least one first reference signal resource configuration.

According to embodiments of the present disclosure, the terminal determines the at least one first reference signal resource configuration based on the reference signal resource configuration configured by the network device, so as to determine one CMR resource set based on the first reference signal resource configuration, and then perform the measurement based on the CMR resource set to obtain the channel state information through the measurement. The present disclosure expands the resource configuration method for determining the CMR resource set, further expands the channel measurement method, and improves the transmission efficiency.

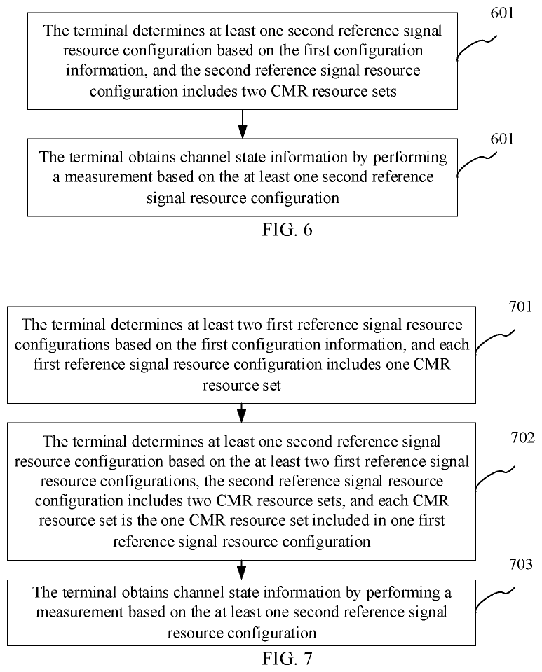

Based on embodiments shown in FIG. 4, the terminal can determine different types of reference signal resource configurations based on the reference signal resource configuration by the network device. FIG. 6 shows a flowchart of a resource determination method according to embodiments of the present disclosure. As shown in FIG. 6, the method includes following steps.

In step 601, the terminal determines at least one second reference signal resource configuration based on the first configuration information, and each of the at least one second reference signal resource configuration includes two CMR resource sets.

In some embodiments of the present disclosure, after receiving the reference signal resource configuration configured by the network device, the terminal can obtain N CMR resource sets, and determine at least one second reference signal resource configuration, each of which includes two CMR resource sets. The two CMR resource sets included each second reference signal resource configuration are different CMR resource sets.

In some embodiments, the second reference signal resource configuration is explicitly configured by the network device. That is, the network device directly configures the second reference signal resource configuration. In some embodiments, the second reference signal resource configuration configured by the network device includes CMR resource set #1 and CMR resource set #2, CMR resource set #1 includes four CMR resources, namely CMR resource 1, CMR resource 2, CMR resource 3, and CMR resource 4, and CMR resource set #2 includes three CMR resources, namely CMR resource 4, CMR resource 5, and CMR resource 6.

In some embodiments, there is at least one different CMR resource between the CMR resource sets included in any two second reference signal resource configurations.

According to embodiments of the present disclosure, the terminal can determine multiple second reference signal resource configurations, each second reference signal resource configuration includes two CMR resource sets, and there is at least one different CMR resource between the CMR resource sets included in every two second reference signal resource configurations. That is, the multiple second reference signal resource configurations determined by the terminal correspond to different combinations of TPRs, and the two CMR resource sets included in each of the multiple second reference signal resource configurations are used to measure the reference signals for different combinations of TPRs.

In some embodiments, that any two second reference signal resource configurations are different means that there is at least one different CMR resource between the CMR resource sets included in any two second reference signal resource configurations.

In some embodiments, all of the CMR resource sets included in any two second reference signal resource configurations are different. In some embodiments, some of the CMR resource sets included in any two second reference signal resource configurations are different.

In some embodiments, the terminal determines two second reference signal resource configurations, namely the second reference signal resource configuration #1 and the second reference signal resource configuration #2. The second reference signal resource configuration #1 includes CMR resource set #1 and CMR resource set #2, the second reference signal resource configuration #2 includes CMR resource set #2 and CMR resource set #3, and there is at least one different CMR resource between CMR resource set #1 and CMR resource set #3. For example, if CMR resource set #1 includes CMR resource #1, CMR resource #2, CMR resource #3, and CMR resource #4, and CMR resource set #3 includes CMR resource #1, CMR resource #2, CMR resource #4, and CMR resource #5, then CMR resource #3 and CMR resource #5 are different between CMR resource set #1 and CMR resource set #3, indicating that the CMR resource sets in the second reference signal resource configuration #1 and the CMR resource sets in the second reference signal resource configuration #2 are different.

In some embodiments, any two second reference signal resource configurations include different IMRs, or any two second reference signal resource configurations include the same IMR. In some embodiments of the present disclosure, any two second reference signal resource configurations determined by the terminal include different CMR resource sets, and any two second reference signal resource configurations include different IMRs, or any two second reference signal resource configurations include the same IMR.

In some embodiments, the second reference signal resource configuration #1 includes CMR resource set #1, CMR resource set #2, and IMR #1 that corresponds to interferences from TRP #3 and TRP #4, and the second reference signal resource configuration #2 includes CMR resource set #2, CMR resource set #3, and IMR #1 that corresponds to interferences from TRP #3 and TRP #4. That is, the CMR resource sets included in the second reference signal resource configuration #1 and the second reference signal resource configuration #2 are different, meaning that the reference signals for different TRPs are used as channel measurement resources, while the IMRs are the same.

In some embodiments, the second reference signal resource configuration #1 includes CMR resource set #1, CMR resource set #2, and IMR #1 that corresponds to interferences from TRP #3 and TRP #4, and the second reference signal resource configuration #2 includes CMR resource set #2, CMR resource set #3, and IMR #2 that corresponds to an interference from TRP #1. That is, the CMR resource sets included in the second reference signal resource configuration #1 and the second reference signal resource configuration #2 are different, and the IMRs are also different.

Explanations will be provided in the following, taking that the network device configures four CMR resource sets for the terminal, and each CMR resource set corresponds to one TRP as an example. In the case as mentioned above, the second reference signal resource configuration determined by the terminal includes at least one of the following cases:
second reference signal resource configuration #1: CMR resource set #1, CMR resource set #2, IMR #1 that corresponds to interferences from TRP #3 and TRP #4, and IMR #2 that corresponds to an interference from TRP #3;
second reference signal resource configuration #2: CMR resource set #2, CMR resource set #3, and IMR #3 that corresponds to an interference from TRP #4.

In some embodiments, the CMR resource sets included in any two second reference signal resource configurations correspond to the same CMR resources.

In some embodiments of the present disclosure, the terminal can determine multiple second reference signal resource configurations, each second reference signal resource configuration includes two CMR resource sets, and all CMR resource sets included in any two second reference signal resource configurations are the same. That is, the CMR resource sets included in the multiple second reference signal resource configurations determined by the terminal all correspond to the same TPRs, and these multiple CMR resource sets are all used to measure the reference signals for the same TRPs.

In some embodiments, the terminal determines two second reference signal resource configurations, namely the second reference signal resource configuration #1 and the second reference signal resource configuration #2, and the CMR resource sets included in the second reference signal resource configuration #1 and the second reference signal resource configuration #2 are the same, which means that the CMR resources included in the CMR resource sets are the same.

In some embodiments, any two second reference signal resource configurations include different IMRs. In some embodiments of the present disclosure, any two second reference signal resource configurations determined by the terminal include the same CMR resource sets, and any two second reference signal resource configurations include different IMRs. Different IMRs correspond to different TRP interferences.

For example, IMR #1 corresponds to interferences from TRP #3 and TRP #4, and IMR #2 corresponds to an interference from TRP #3.

Explanations will be provided in the following, taking that the network device configures four CMR resource sets for the terminal, and each CMR resource set corresponds to one TRP as an example. In the case as mentioned above, the second reference signal resource configuration determined by the terminal includes at least one of the following cases:
second reference signal resource configuration #1: CMR resource set #1, CMR resource set #2, and IMR #1 that corresponds to interferences from TRP #3 and TRP #4;
second reference signal resource configuration #2: CMR resource set #1, CMR resource set #2, and IMR #2 that corresponds to an interference from TRP #3;
second reference signal resource configuration #3: CMR resource set #1, CMR resource set #2, and IMR #3 that corresponds to an interference from TRP #4.

It should be noted that in the above embodiments, that one second reference signal resource configuration corresponds to one IMR resource is taken an example, while in some embodiments, one second reference signal resource configuration can correspond to multiple IMR resources.

For example, that one second reference signal resource configuration corresponds to multiple IMR resources includes at least one of the following cases:
second reference signal resource configuration #1: CMR resource set #1, CMR resource set #2, IMR #1 that corresponds to interferences from TRP #3 and TRP #4, and IMR #2 that corresponds to an interference from TRP #3;
second reference signal resource configuration #2: CMR resource set #1, CMR resource set #2, and IMR #3 that corresponds to an interference from TRP #4.

It should be noted that if the second reference signal resource configuration includes all cases of IMRs, then that any two second reference signal resource configurations include the same CMR resource sets will not occur.

In step 602, the terminal obtains channel state information by performing a measurement based on the at least one second reference signal resource configuration.

According to embodiments of the present disclosure, the terminal determines the at least one second reference signal resource configuration based on the reference signal resource configuration configured by the network device, so as to determine two CMR resource sets based on the second reference signal resource configuration, and then perform the measurement based on the CMR resource sets to obtain the channel state information through the measurement. The present disclosure expands the resource configuration method for determining the CMR resource set, further expands the channel measurement method, and improves the transmission efficiency.

It should be noted that FIG. 6 only shows an example where the terminal directly determines the at least one second reference signal resource configuration based on the first configuration information. In some embodiments of the present disclosure, the terminal can also determine the first reference signal resource configuration first, and then determine the second reference signal resource configuration based on the first reference signal resource configuration. FIG. 7 shows a flowchart of a resource determination method according to embodiments of the present disclosure. As shown in FIG. 7, the method includes following steps.

In step 701, the terminal determines at least two first reference signal resource configurations based on the first configuration information, and each first reference signal resource configuration includes one CMR resource set.

The first reference signal resource configuration in present embodiment is similar to the first reference signal resource configuration in the above embodiments, which will not be repeated here.

The present embodiment differs from the above embodiments in that, the terminal will determine at least two first reference signal resource configurations based on the first configuration information, and there are two first reference signal resource configurations that include different CMR resource sets.

In step 702, the terminal determines at least one second reference signal resource configuration based on the at least two first reference signal resource configurations. The second reference signal resource configuration includes two CMR resource sets, and each CMR resource set is the one CMR resource set included in one first reference signal resource configuration.

In some embodiments of the present disclosure, after determining the at least two first reference signal resource configurations, the terminal can determine at least one second reference signal resource configuration based on the at least two first reference signal resource configurations determined. The second reference signal resource configuration includes two CMR resource sets, and each CMR resource set included in the second reference signal resource configuration is the CMR resource set included in the first reference signal resource configurations.

In some embodiments of the present disclosure, the second reference signal resource configuration and the first reference signal resource configuration share the CMR resource sets. If the second reference signal resource configuration #1 includes CMR resource set 1 and CMR resource set 2, then the CMR resource set 1 can be obtained from the first reference signal resource configuration #1 that includes this CMR resource set 1, and the CMR resource set 2 can be obtained from the first reference signal resource configuration #2 that includes this CMR resource set 2.

In some embodiments, there is at least one different CMR resource between the CMR resource sets included in any two second reference signal resource configurations.

In some embodiments, any two second reference signal resource configurations include different IMRs, or any two second reference signal resource configurations include the same IMR.

In some embodiments, the CMR resource sets included in any two second reference signal resource configurations correspond to the same CMR resources.

In some embodiments, any two second reference signal resource configurations include different IMRs.

The second reference signal resource configuration in present embodiment is similar to the second reference signal resource configuration in the above embodiments, which will not be repeated here.

It should be noted that the first configuration information indicates at least two first reference signal resource configurations, and each first reference signal resource configuration includes one CMR resource set. The terminal determines at least one second reference signal resource configuration based on the at least two first reference signal resource configurations, and the second reference signal resource configuration includes two CMR resource sets. Each CMR resource set in the second reference signal resource configuration is the one CMR resource set included in one first reference signal resource configuration. Therefore, steps 701-702 can be executed based on the first configuration information.

In step 703, the terminal obtains channel state information by performing a measurement based on the at least one second reference signal resource configuration.

The step 703 is similar to the above embodiments, and will not be repeated here.

It should be noted that embodiments of the present disclosure are only explained by taking that the terminal determines the second reference signal resource configuration based on the first reference signal resource configuration as an example. In addition, before determining the second reference signal resource configuration, the network device sends the second configuration information to the terminal, and the terminal receives the second configuration information. The second configuration information is configured to indicate that the second reference signal resource configuration and the first reference signal resource configuration share the CMR resource sets. That is, after receiving the second configuration information, the terminal determines that the second reference signal resource configuration can be determined through the first reference signal resource configuration, and then the terminal begins to execute the above steps 701-703, so as to perform the measurement based on the at least one second reference signal resource configuration determined.

It should be understood that the second configuration information can be sent separately or together with the first configuration information, and the present disclosure does not limit this.

In some embodiments, by executing steps 701-702, the second reference signal resource configuration can be determined based on the first reference signal resource configuration. That is, embodiments shown in FIG. 7 implicitly configures the second reference signal resource configuration.

According to embodiments of the present disclosure, the terminal determines at least two first reference signal resource configurations based on the reference signal resource configuration configured by the network device, and each first reference signal resource configuration includes one CMR resource set. The terminal then determines at least one second reference signal resource configuration based on the at least two first reference signal resource configurations, so as to determine two CMR resource sets based on the second reference signal resource configuration. The terminal then performs the measurement based on the CMR resource sets to obtain the channel state information through the measurement. The present disclosure expands the resource configuration method for determining the CMR resource set, further expands the channel measurement method, and improves the transmission efficiency.

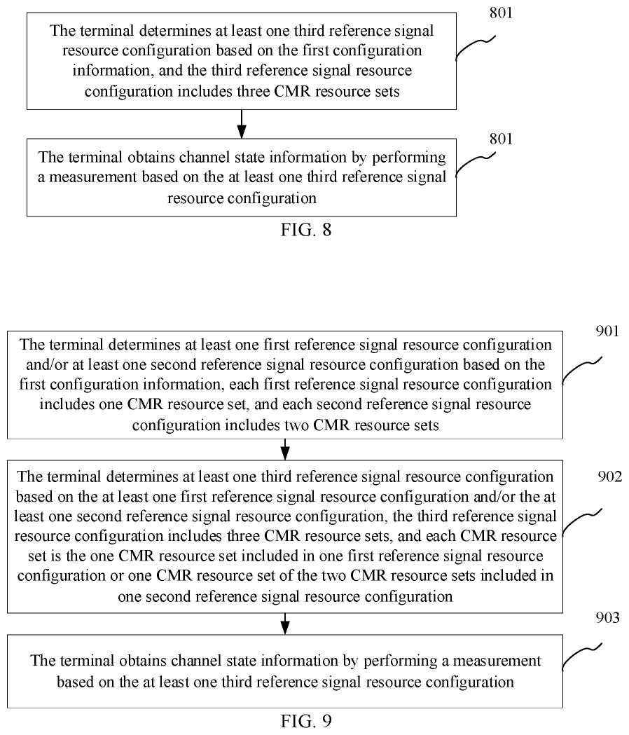

Based on embodiments shown in FIG. 4, the terminal can determine different types of reference signal resource configurations based on the reference signal resource configuration by the network device. FIG. 8 shows a flowchart of a resource determination method according to embodiments of the present disclosure. As shown in FIG. 8, the method includes following steps.

In step 801, the terminal determines at least one third reference signal resource configuration based on the first configuration information, and each of the at least one third reference signal resource configuration includes three CMR resource sets.

In some embodiments of the present disclosure, after receiving the reference signal resource configuration configured by the network device, the terminal can obtain N CMR resource sets, and determine at least one third reference signal resource configuration, each of which includes three CMR resource sets. The three CMR resource sets included each third reference signal resource configuration are different CMR resource sets.

In some embodiments, the third reference signal resource configuration is explicitly configured by the network device. That is, the network device directly configures the third reference signal resource configuration. In some embodiments, the third reference signal resource configuration configured by the network device includes CMR resource set #1, CMR resource set #2, and CMR resource set #3. The CMR resource set #1 includes four CMR resources, namely CMR resource 1, CMR resource 2, CMR resource 3, and CMR resource 4, the CMR resource set #2 includes three CMR resources, namely CMR resource 4, CMR resource 5, and CMR resource 6, and the CMR resource set #3 includes three CMR resources, namely CMR resource 7, CMR resource 8, and CMR resource 9.

In some embodiments, there is at least one different CMR resource between the CMR resource sets included in any two third reference signal resource configurations.

According to embodiments of the present disclosure, the terminal can determine multiple third reference signal resource configurations, each third reference signal resource configuration includes three CMR resource sets, and there is at least one different CMR resource between the CMR resource sets included in every two third reference signal resource configurations. That is, the multiple third reference signal resource configurations determined by the terminal all correspond to different combinations of TPRs, and the CMR resource sets included in each of the multiple third reference signal resource configurations are used to measure the reference signals for different combinations of TPRs.

In some embodiments, that any two third reference signal resource configurations are different means that there is at least one different CMR resource between the CMR resource sets included in any two third reference signal resource configurations.

In some embodiments, all of the CMR resource sets included in any two third reference signal resource configurations are different. In some embodiments, some of the CMR resource sets included in any two third reference signal resource configurations are the same.

In some embodiments, the terminal determines two third reference signal resource configurations, namely the third reference signal resource configuration #1 and the third reference signal resource configuration #2. The third reference signal resource configuration #1 includes CMR resource set #1, CMR resource set #2, and CMR resource set #3, the third reference signal resource configuration #2 includes CMR resource set #2, CMR resource set #3, and CMR resource set #4, and there is at least one different CMR resource between CMR resource set #1 and CMR resource set #4. For example, if CMR resource set #1 includes CMR resource #1, CMR resource #2, CMR resource #3, and CMR resource #4, and CMR resource set #4 includes CMR resource #1, CMR resource #2, CMR resource #4, and CMR resource #5, then CMR resource #3 and CMR resource #5 are different between CMR resource set #1 and CMR resource set #4, indicating that the CMR resource sets in the third reference signal resource configuration #1 and the CMR resource sets in the third reference signal resource configuration #2 are different.

In some embodiments, any two third reference signal resource configurations include different IMRs, or any two third reference signal resource configurations include the same IMR. In some embodiments of the present disclosure, any two third reference signal resource configurations determined by the terminal include different CMR resource sets, and any two third reference signal resource configurations include different IMRs, or any two third reference signal resource configurations include the same IMR.

In some embodiments, the third reference signal resource configuration #1 includes CMR resource set #1, CMR resource set #2, CMR resource set #3, and IMR #1 that corresponds to an interference from TRP #4, and the third reference signal resource configuration #2 includes CMR resource set #2, CMR resource set #3, CMR resource set #4, and IMR #1 that corresponds to an interference from TRP #4. That is, the CMR resource sets included in the third reference signal resource configuration #1 and the third reference signal resource configuration #2 are different, while the IMRs are the same.

In some embodiments, the third reference signal resource configuration #1 includes CMR resource set #1, CMR resource set #2, CMR resource set #3, and IMR #1 that corresponds to an interference from TRP #4, and the third reference signal resource configuration #2 includes CMR resource set #2, CMR resource set #3, CMR resource set #4, and IMR #2 that corresponds to an interference from TRP #1. That is, the CMR resource sets included in the third reference signal resource configuration #1 and the third reference signal resource configuration #2 are different, and the IMRs are also different.

In some embodiments, the CMR resource sets included in any two third reference signal resource configurations correspond to the same CMR resources.

In some embodiments of the present disclosure, the terminal can determine multiple third reference signal resource configurations, each third reference signal resource configuration includes three CMR resource sets, and all CMR resource sets included in each third reference signal resource configuration are the same. That is, the multiple third reference signal resource configurations determined by the terminal all correspond to the same combination of TRPs, and the CMR resource sets included in the multiple third reference signal resource configurations are all used to measure the reference signals for the same combination of TRPs.

In some embodiments, the terminal determines two third reference signal resource configurations, namely the third reference signal resource configuration #1 and the third reference signal resource configuration #2, and the CMR resource sets included in the third reference signal resource configuration #1 and the third reference signal resource configuration #2 are the same, which means that the CMR resources included in the CMR resource sets are the same.

In some embodiments, any two third reference signal resource configurations include different IMRs. In some embodiments of the present disclosure, any two third reference signal resource configurations determined by the terminal include the same CMR resource sets, and any two third reference signal resource configurations include different IMRs. Different IMRs correspond to different TRP interferences.

For example, IMR #1 corresponds to an interference from TRP #4, and IMR #2 corresponds to an interference from TRP #1.

It should be noted that if the third reference signal resource configuration includes all cases of IMRs, then that any two third reference signal resource configurations include the same CMR resource sets will not occur.

In step 802, the terminal obtains channel state information by performing a measurement based on the at least one third reference signal resource configuration.

According to embodiments of the present disclosure, the terminal determines the at least one third reference signal resource configuration based on the reference signal resource configuration configured by the network device, so as to determine three CMR resource sets based on the third reference signal resource configuration, and then perform the measurement based on the CMR resource sets to obtain the channel state information through the measurement. The present disclosure expands the resource configuration method for determining the CMR resource set, further expands the channel measurement method, and improves the transmission efficiency.

It should be noted that FIG. 8 only shows an example where the terminal directly determines the at least one third reference signal resource configuration based on the first configuration information. In some embodiments of the present disclosure, the terminal can also determine the first reference signal resource configuration and/or the second reference signal resource configuration first, and then determine the third reference signal resource configuration based on the first reference signal resource configuration and/or the second reference signal resource configuration. FIG. 9 shows a flowchart of a resource determination method according to embodiments of the present disclosure. As shown in FIG. 9, the method includes following steps.

In step 901, the terminal determines at least one first reference signal resource configuration and/or at least one second reference signal resource configuration based on the first configuration information, each first reference signal resource configuration includes one CMR resource set, and each second reference signal resource configuration includes two CMR resource sets.

According to embodiments of the present disclosure, the terminal can determine at least one first reference signal resource configuration and/or at least one second reference signal resource configuration based on the first configuration information, and steps executed by the terminal to determine the first reference signal resource configuration and the second reference signal resource configuration are similar to the method embodiments provided in FIGS. 4-8, which will not be repeated here.

In step 902, the terminal determines at least one third reference signal resource configuration based on the at least one first reference signal resource configuration and/or the at least one second reference signal resource configuration. The third reference signal resource configuration includes three CMR resource sets, and each CMR resource set is the one CMR resource set included in one first reference signal resource configuration or one CMR resource set of the two CMR resource sets included in one second reference signal resource configuration.

In some embodiments of the present disclosure, after determining the at least one first reference signal resource configuration and/or the at least one second reference signal resource configuration, the terminal can determine at least one third reference signal resource configuration based on the first reference signal resource configuration and/or the second reference signal resource configuration determined. The third reference signal resource configuration includes three CMR resource sets, and each CMR resource set included in the third reference signal resource configuration is the CMR resource set included in the first reference signal resource configuration, or one CMR resource set of the two CMR resource sets included in the second reference signal resource configuration.

In some embodiments of the present disclosure, the third reference signal resource configuration shares the CMR resource sets with the first reference signal resource configuration and/or the second reference signal resource configuration. If the third reference signal resource configuration #1 includes CMR resource set #1, CMR resource set #2, and CMR resource set #3, then the CMR resource set #1 can be obtained from the first reference signal resource configuration and/or the second reference signal resource configuration that includes this CMR resource set #1, the CMR resource set #2 can be obtained from the first reference signal resource configuration and/or the second reference signal resource configuration that includes this CMR resource set #2, and the CMR resource set #3 can be obtained from the first reference signal resource configuration and/or the second reference signal resource configuration that includes this CMR resource set #3.

It should be noted that in embodiments of the present disclosure, the first reference signal resource configuration and/or the second reference signal resource configuration to be used for determining the third reference signal resource configuration depend on which reference signal resource configurations the terminal determines based on the first configuration information. In some embodiments, if the terminal determines multiple first reference signal resource configurations, then the terminal determines the at least one third reference signal resource configuration based on the multiple first reference signal resource configurations. In some embodiments, if the terminal determines one first reference signal resource configuration and one second reference signal resource configuration, then the terminal determines the at least one third reference signal resource configuration based on the one first reference signal resource configuration and the one second reference signal resource configuration determined.

In some embodiments, there is at least one different CMR resource between the CMR resource sets included in any two third reference signal resource configurations.

In some embodiments, any two third reference signal resource configurations include different IMRs, or any two third reference signal resource configurations include the same IMR.

In some embodiments, the CMR resource sets included in any two third reference signal resource configurations correspond to the same CMR resources.

In some embodiments, any two third reference signal resource configurations include different IMRs.

The third reference signal resource configuration in present embodiment is similar to the third reference signal resource configuration in the above embodiments, which will not be repeated here.

It should be noted that the first configuration information indicates at least one first reference signal resource configuration and/or at least one second reference signal resource configuration. Each first reference signal resource configuration includes one CMR resource set, and each second reference signal resource configuration includes two CMR resource sets. The terminal determines at least one third reference signal resource configuration based on the at least one first reference signal resource configuration and/or the at least one second reference signal resource configuration. The third reference signal resource configuration includes three CMR resource sets, and each CMR resource set is the one CMR resource set included in one first reference signal resource configuration, or one CMR resource set of the two CMR resource sets included in one second reference signal resource configuration. Therefore, steps 901-902 can be executed based on the first configuration information.

In step 903, the terminal obtains channel state information by performing a measurement based on the at least one third reference signal resource configuration.

The step 903 is similar to the above embodiments, and will not be repeated here.

It should be noted that embodiments of the present disclosure are only explained by taking that the terminal determines the third reference signal resource configuration based on the first reference signal resource configuration and/or the second reference signal resource configuration as an example. In addition, before determining the third reference signal resource configuration, the network device sends the third configuration information and/or the fourth configuration information to the terminal. The third configuration information is configured to indicate that the third reference signal resource configuration and the first reference signal resource configuration share the CMR resource sets, and the fourth configuration information is configured to indicate that the third reference signal resource configuration and the second reference signal resource configuration share the CMR resource sets. After receiving the third configuration information and/or the fourth configuration information, the terminal determines based on the third configuration information that the third reference signal resource configuration can be determined through the first reference signal resource configuration, and determines based on the fourth configuration information that the third reference signal resource configuration can be determined through the second reference signal resource configuration. Then the terminal begins to execute the above steps 901-903, so as to perform the measurement based on the at least one third reference signal resource configuration determined.

For example, if the third configuration information is received, it determines that the terminal determines the third reference signal resource configuration based on the first reference signal resource configuration. If the fourth configuration information is received, it determines that the terminal determines the third reference signal resource configuration based on the second reference signal resource configuration. If the third configuration information and the fourth configuration information are both received, it determines that the terminal determines the third reference signal resource configuration based on the first reference signal resource configuration and the second reference signal resource configuration.

It should be noted that in embodiments of the present disclosure, the third configuration information and the fourth configuration information can be different, or the third configuration information and the fourth configuration information can also be the same. In some embodiments, if the third configuration information and the fourth configuration information are the same, it means that one configuration information can be used to simultaneously indicate that the third reference signal resource configuration and the first reference signal resource configuration share the CMR resource sets, and that the third reference signal resource configuration and the second reference signal resource configuration share the CMR resource sets. In some embodiments, the third configuration information can be sent separately or together with the first configuration information. Similarly, in some embodiments, the fourth configuration information can be sent separately or together with the first configuration information, which is not limited in the present disclosure.

In some embodiments, by executing steps 901-902, the third reference signal resource configuration can be determined based on the first reference signal resource configuration and/or the second reference signal resource configuration. That is, embodiments shown in FIG. 9 implicitly configures the third reference signal resource configuration.

According to embodiments of the present disclosure, the terminal determines at least one first reference signal resource configuration and/or at least one second reference signal resource configuration based on the reference signal resource configuration configured by the network device, and then determines at least one third reference signal resource configuration based on the at least one first reference signal resource configuration and/or the at least one second reference signal resource configuration, so as to determine three CMR resource sets based on the third reference signal resource configuration. The terminal then performs the measurement based on the CMR resource sets to obtain the channel state information through the measurement. The present disclosure expands the resource configuration method for determining the CMR resource set, further expands the channel measurement method, and improves the transmission efficiency.

Based on embodiments shown in FIG. 4, the terminal can determine different types of reference signal resource configurations based on the reference signal resource configuration by the network device. FIG. 10 shows a flowchart of a resource determination method according to embodiments of the present disclosure. As shown in FIG. 10, the method includes following steps.

In step 1001, the terminal determines at least one fourth reference signal resource configuration based on the first configuration information, and each of the at least one fourth reference signal resource configuration includes four CMR resource sets.

In some embodiments of the present disclosure, after receiving the reference signal resource configuration configured by the network device, the terminal can obtain N CMR resource sets, and determine at least one fourth reference signal resource configuration, each of which includes four CMR resource sets. The four CMR resource sets included each fourth reference signal resource configuration are different CMR resource sets.

In some embodiments, the fourth reference signal resource configuration is explicitly configured by the network device. That is, the network device directly configures the fourth reference signal resource configuration. In some embodiments, the fourth reference signal resource configuration configured by the network device includes CMR resource set #1, CMR resource set #2, CMR resource set #3, and CMR resource set #4. The CMR resource set #1 includes four CMR resources, namely CMR resource 1, CMR resource 2, CMR resource 3, and CMR resource 4, the CMR resource set #2 includes three CMR resources, namely CMR resource 4, CMR resource 5, and CMR resource 6, the CMR resource set #3 includes three CMR resources, namely CMR resource 7, CMR resource 8, and CMR resource 9, and the CMR resource set #4 includes three CMR resources, namely CMR resource 10, CMR resource 11, and CMR resource 12.

In some embodiments, there is at least one different CMR resource between the CMR resource sets included in any two fourth reference signal resource configurations.

According to embodiments of the present disclosure, the terminal can determine multiple fourth reference signal resource configurations, each fourth reference signal resource configuration includes four CMR resource sets, and there is at least one different CMR resource between the CMR resource sets included in every two fourth reference signal resource configurations. That is, the multiple fourth reference signal resource configurations determined by the terminal all correspond to different combinations of TPRs, and the CMR resource sets included in each of the multiple fourth reference signal resource configurations are used to measure the reference signals for different combinations of TPRs.

In some embodiments, that any two fourth reference signal resource configurations are different means that there is at least one different CMR resource between the CMR resource sets included in any two fourth reference signal resource configurations.

In some embodiments, all of the CMR resource sets included in any two fourth reference signal resource configurations are different. In some embodiments, some of the CMR resource sets included in any two fourth reference signal resource configurations are the same.

In some embodiments, the terminal determines two fourth reference signal resource configurations, namely the fourth reference signal resource configuration #1 and the fourth reference signal resource configuration #2. The fourth reference signal resource configuration #1 includes CMR resource set #1, CMR resource set #2, CMR resource set #3, and CMR resource set #4, the fourth reference signal resource configuration #2 includes CMR resource set #2, CMR resource set #3, CMR resource set #4, and CMR resource set #5, and there is at least one different CMR resource between CMR resource set #1 and CMR resource set #5. For example, if CMR resource set #1 includes CMR resource #1, CMR resource #2, CMR resource #3, and CMR resource #4, and CMR resource set #5 includes CMR resource #1, CMR resource #2, CMR resource #4, and CMR resource #5, then CMR resource #3 and CMR resource #5 are different between CMR resource set #1 and CMR resource set #5, indicating that the CMR resource sets in the fourth reference signal resource configuration #1 and the CMR resource sets in the fourth reference signal resource configuration #2 are different.

In some embodiments, any two fourth reference signal resource configurations include different IMRs, or any two fourth reference signal resource configurations include the same IMR. In some embodiments of the present disclosure, any two fourth reference signal resource configurations determined by the terminal include different CMR resource sets, and any two fourth reference signal resource configurations include different IMRs, or any two fourth reference signal resource configurations include the same IMR.

In some embodiments, the fourth reference signal resource configuration #1 includes CMR resource set #1, CMR resource set #2, CMR resource set #3, CMR resource set #4, and IMR #1 that corresponds to an interference from TRP #1, and the fourth reference signal resource configuration #2 includes CMR resource set #2, CMR resource set #3, CMR resource set #4, CMR resource set #5, and IMR #1 that corresponds to an interference from TRP #1. That is, the CMR resource sets included in the fourth reference signal resource configuration #1 and the fourth reference signal resource configuration #2 are different, while the IMRs are the same.

In some embodiments, the fourth reference signal resource configuration #1 includes CMR resource set #1, CMR resource set #2, CMR resource set #3, CMR resource set #4, and IMR #1 that corresponds to an interference from TRP #4, and the fourth reference signal resource configuration #2 includes CMR resource set #2, CMR resource set #3, CMR resource set #4, CMR resource set #5, and IMR #2 that corresponds to an interference from TRP #1. That is, the CMR resource sets included in the fourth reference signal resource configuration #1 and the fourth reference signal resource configuration #2 are different, and the IMRs are also different.

In some embodiments, the CMR resource sets included in any two fourth reference signal resource configurations correspond to the same CMR resources.

In some embodiments of the present disclosure, the terminal can determine multiple fourth reference signal resource configurations, each fourth reference signal resource configuration includes four CMR resource sets, and all CMR resource sets included in each fourth reference signal resource configuration are the same. That is, the multiple fourth reference signal resource configurations determined by the terminal all correspond to the same combination of TRPs, and the CMR resource sets included in the multiple fourth reference signal resource configurations are all used to measure the reference signals for the same combination of TRPs.

In some embodiments, the terminal determines two fourth reference signal resource configurations, namely the fourth reference signal resource configuration #1 and the fourth reference signal resource configuration #2, and the CMR resource sets included in the fourth reference signal resource configuration #1 and the fourth reference signal resource configuration #2 are the same, which means that the CMR resources included in the CMR resource sets are the same.

In some embodiments, any two fourth reference signal resource configurations include different IMRs. In some embodiments of the present disclosure, any two fourth reference signal resource configurations determined by the terminal include the same CMR resource sets, and any two fourth reference signal resource configurations include different IMRs. Different IMRs correspond to different TRP interferences.

For example, IMR #1 corresponds to an interference from TRP #4, and IMR #2 corresponds to an interference from TRP #1.

It should be noted that if the fourth reference signal resource configuration includes all cases of IMRs, then that any two fourth reference signal resource configurations include the same CMR resource sets will not occur.

In step 1002, the terminal obtains channel state information by performing a measurement based on the at least one fourth reference signal resource configuration.

According to embodiments of the present disclosure, the terminal determines the at least one fourth reference signal resource configuration based on the reference signal resource configuration configured by the network device, so as to determine four CMR resource sets based on the fourth reference signal resource configuration, and then perform the measurement based on the CMR resource sets to obtain the channel state information through the measurement. The present disclosure expands the resource configuration method for determining the CMR resource set, further expands the channel measurement method, and improves the transmission efficiency.

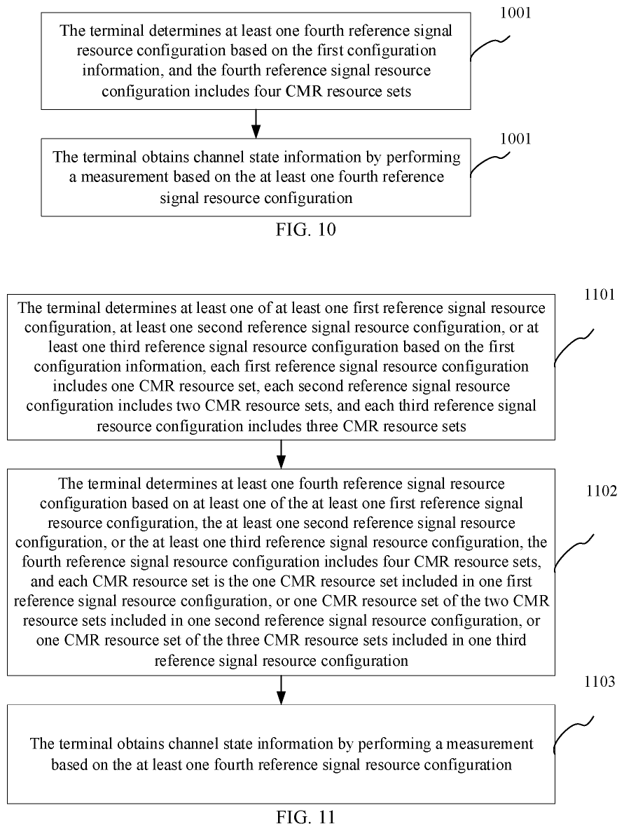

It should be noted that FIG. 10 only shows an example where the terminal directly determines the at least one fourth reference signal resource configuration based on the first configuration information. In some embodiments of the present disclosure, the terminal can also determine at least one of the first reference signal resource configuration, the second reference signal resource configuration, or the third reference signal resource configuration first, and then determine the fourth reference signal resource configuration based on the at least one of the first reference signal resource configuration, the second reference signal resource configuration, or the third reference signal resource configuration. FIG. 11 shows a flowchart of a resource determination method according to embodiments of the present disclosure. As shown in FIG. 11, the method includes following steps.

In step 1101, the terminal determines at least one of at least one first reference signal resource configuration, at least one second reference signal resource configuration, or at least one third reference signal resource configuration based on the first configuration information. Each first reference signal resource configuration includes one CMR resource set, each second reference signal resource configuration includes two CMR resource sets, and each third reference signal resource configuration includes three CMR resource sets.

According to embodiments of the present disclosure, the terminal can determine, based on the first configuration information, at least one first reference signal resource configuration, at least one second reference signal resource configuration, and at least one third reference signal resource configuration. The steps executed by the terminal to determine at least one of the first reference signal resource configuration, the second reference signal resource configuration, or the third reference signal resource configuration are similar to the method embodiments provided in FIGS. 4-10, which will not be repeated here.

In step 1102, the terminal determines at least one fourth reference signal resource configuration based on at least one of the at least one first reference signal resource configuration, the at least one second reference signal resource configuration, or the at least one third reference signal resource configuration. The fourth reference signal resource configuration includes four CMR resource sets, and each CMR resource set is the one CMR resource set included in one first reference signal resource configuration, or one CMR resource set of the two CMR resource sets included in one second reference signal resource configuration, or one CMR resource set of the three CMR resource sets included in one third reference signal resource configuration.

In some embodiments of the present disclosure, after determining at least one of the at least one first reference signal resource configuration, the at least one second reference signal resource configuration, or the at least one third reference signal resource configuration, the terminal can determine at least one fourth reference signal resource configuration based on the at least one of the first reference signal resource configuration, the second reference signal resource configuration, or the third reference signal resource configuration, which have been determined. The fourth reference signal resource configuration includes four CMR resource sets. Each CMR resource set included in the fourth reference signal resource configuration is the CMR resource set included in the first reference signal resource configuration, or one CMR resource set of the two CMR resource sets included in the second reference signal resource configuration, or one CMR resource set of the three CMR resource sets included in the third reference signal resource configuration.

In some embodiments of the present disclosure, the fourth reference signal resource configuration shares the CMR resource sets with at least one of the first reference signal resource configuration, the second reference signal resource configuration, and the third reference signal resource configuration. If the fourth reference signal resource configuration #1 includes CMR resource set #1, CMR resource set #2, CMR resource set #3, and CMR resource set #4, then the CMR resource set #1 can be obtained from at least one of the first reference signal resource configuration, the second reference signal resource configuration, or the third reference signal resource configuration that includes this CMR resource set #1, the CMR resource set #2 can be obtained from at least one of the first reference signal resource configuration, the second reference signal resource configuration, or the third reference signal resource configuration that includes this CMR resource set #2, the CMR resource set #3 can be obtained from at least one of the first reference signal resource configuration, the second reference signal resource configuration, or the third reference signal resource configuration that includes this CMR resource set #3, and the CMR resource set #4 can be obtained from at least one of the first reference signal resource configuration, the second reference signal resource configuration, or the third reference signal resource configuration that includes this CMR resource set #4.

It should be noted that in embodiments of the present disclosure, at least one of the first reference signal resource configuration, the second reference signal resource configuration, or the third reference signal resource configuration to be used for determining the fourth reference signal resource configuration depends on which reference signal resource configurations the terminal determines based on the first configuration information. In some embodiments, if the terminal determines multiple first reference signal resource configurations, then the terminal determines the at least one fourth reference signal resource configuration based on the multiple first reference signal resource configurations. In some embodiments, if the terminal determines one first reference signal resource configuration, one second reference signal resource configuration, and one third reference signal resource configuration, then the terminal determines the at least one fourth reference signal resource configuration based on the one first reference signal resource configuration, the one second reference signal resource configuration, and the one third reference signal resource configuration, which have been determined.

In some embodiments, there is at least one different CMR resource between the CMR resource sets included in any two fourth reference signal resource configurations.

In some embodiments, any two fourth reference signal resource configurations include different IMRs, or any two fourth reference signal resource configurations include the same IMR.

In some embodiments, the CMR resource sets included in any two fourth reference signal resource configurations correspond to the same CMR resources.

In some embodiments, any two fourth reference signal resource configurations include different IMRs.

The fourth reference signal resource configuration in present embodiment is similar to the fourth reference signal resource configuration in the above embodiments, which will not be repeated here.

It should be noted that the first configuration information indicates at least one of the at least one first reference signal resource configuration, the at least one second reference signal resource configuration, or the at least one third reference signal resource configuration. Each first reference signal resource configuration includes one CMR resource set, each second reference signal resource configuration includes two CMR resource sets, and each third reference signal resource configuration includes three CMR resource sets. The terminal determines the at least one fourth reference signal resource configuration based on at least one of the at least one first reference signal resource configuration, the at least one second reference signal resource configuration, or the at least one third reference signal resource configuration. The fourth reference signal resource configuration includes four CMR resource sets, and each CMR resource set is the one CMR resource set included in one first reference signal resource configuration, or one CMR resource set of the two CMR resource sets included in one second reference signal resource configuration, or one CMR resource set of the three CMR resource sets included in one third reference signal resource configuration. Therefore, steps 1101-1102 can be executed based on the first configuration information.

In step 1103, the terminal obtains channel state information by performing a measurement based on the at least one fourth reference signal resource configuration.

The step 1103 is similar to the above embodiments, and will not be repeated here.

It should be noted that embodiments of the present disclosure are only explained by taking that the terminal determines the fourth reference signal resource configuration based on at least one of the first reference signal resource configuration, the second reference signal resource configuration, or the third reference signal resource configuration as an example. In addition, before determining the fourth reference signal resource configuration, the network device sends the fifth configuration information, and/or the sixth configuration information, and/or the seventh configuration information to the terminal. The fifth configuration information is configured to indicate that the fourth reference signal resource configuration and the first reference signal resource configuration share the CMR resource sets, the sixth configuration information is configured to indicate that the fourth reference signal resource configuration and the second reference signal resource configuration share the CMR resource sets, and the seventh configuration information is configured to indicate that the fourth reference signal resource configuration and the third reference signal resource configuration share the CMR resource sets. After receiving the fifth configuration information and/or the sixth configuration information and/or the seventh configuration information, the terminal determines based on the fifth configuration information that the fourth reference signal resource configuration can be determined through the first reference signal resource configuration, determines based on the sixth configuration information that the fourth reference signal resource configuration can be determined through the second reference signal resource configuration, and determines based on the seventh configuration information that the fourth reference signal resource configuration can be determined through the third reference signal resource configuration. Then the terminal begins to execute the above steps 1101-1103, so as to perform the measurement based on the at least one fourth reference signal resource configuration determined.

For example, if the fifth configuration information is received, it determines that the terminal determines the fourth reference signal resource configuration based on the first reference signal resource configuration. If the sixth configuration information is received, it determines that the terminal determines the fourth reference signal resource configuration based on the second reference signal resource configuration. If the seventh configuration information is received, it determines that the terminal determines the fourth reference signal resource configuration based on the third reference signal resource configuration. If the fifth configuration information, the sixth configuration information, and the seventh configuration information are all received, it determines that the terminal determines the fourth reference signal resource configuration based on the first reference signal resource configuration, the second reference signal resource configuration, and the third reference signal resource configuration.

It should be noted that in embodiments of the present disclosure, the fifth configuration information, the sixth configuration information, and the seventh configuration information can be different, or the fifth configuration information, the sixth configuration information, and the seventh configuration information can also be the same. In some embodiments, if the fifth configuration information, the sixth configuration information, and the seventh configuration information are the same, it means that one configuration information can be used to simultaneously indicate that the fourth reference signal resource configuration and the first reference signal resource configuration share the CMR resource sets, that the fourth reference signal resource configuration and the second reference signal resource configuration share the CMR resource sets, and that the fourth reference signal resource configuration and the third reference signal resource configuration share the CMR resource sets. In some embodiments, the fifth configuration information can be sent separately or together with the first configuration information. Similarly, in some embodiments, the sixth configuration information or the seventh configuration information can be sent separately or together with the first configuration information, which is not limited in the present disclosure.

In some embodiments, by executing steps 1101-1102, the fourth reference signal resource configuration can be determined based on at least one of the first reference signal resource configuration, the second reference signal resource configuration, or the third reference signal resource configuration. That is, embodiments shown in FIG. 11 implicitly configures the fourth reference signal resource configuration.

According to embodiments of the present disclosure, the terminal determines at least one of the at least one first reference signal resource configuration, the at least one second reference signal resource configuration, or the at least one third reference signal resource configuration based on the reference signal resource configuration configured by the network device. The terminal then determines at least one fourth reference signal resource configuration based on the at least one first reference signal resource configuration, the at least one second reference signal resource configuration, and the at least one third reference signal resource configuration, so as to determine four CMR resource sets based on the fourth reference signal resource configuration. The terminal then performs the measurement based on the CMR resource sets to obtain the channel state information through the measurement. The present disclosure expands the resource configuration method for determining the CMR resource set, further expands the channel measurement method, and improves the transmission efficiency.

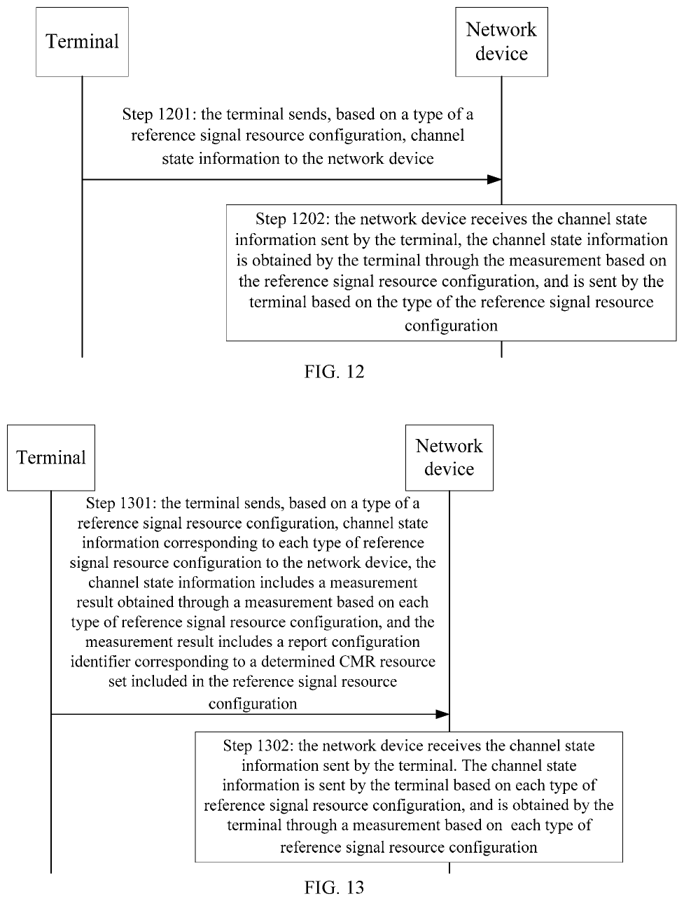

Based on embodiments shown in FIG. 4, the terminal can determine different types of reference signal resource configurations based on the reference signal resource configuration by the network device. FIG. 12 shows a flowchart of an information transmission method according to embodiments of the present disclosure. As shown in FIG. 12, the method includes following steps.

In step 1201, the terminal sends, based on a type of a reference signal resource configuration, channel state information to the network device.

The channel state information includes a measurement result obtained through the measurement based on one determined type of reference signal resource configuration out of at least one type of reference signal resource configuration, and the measurement result includes a report configuration identifier corresponding to a determined CMR resource set included in the reference signal resource configuration determined.

In some embodiments of the present disclosure, one group of channel state information is sent for all types of reference signal resource configurations. In some embodiments, all types of reference signal resource configurations include at least one of the first reference signal resource configuration, the second reference signal resource configuration, the third reference signal resource configuration, or the fourth reference signal resource configuration. In some embodiments, even if the terminal is configured with multiple types of reference signal resource configurations (for example, four types of reference signal resource configurations), the channel state information reported by the terminal includes only the measurement result obtained through the measurement based on one of the multiple types of reference signal resource configurations. For example, the terminal reports the measurement result obtained through the measurement that is based on the third reference signal resource configuration. It can also be understood that the terminal determines the quantity X of the TRPs and also determines a combination including X TRPs. The combination of TRPs can include one or more TRPs. If the terminal reports the measurement result obtained based on the first reference signal resource configuration, then the terminal determines to use a single TRP for transmission. If the terminal reports the measurement result obtained based on the second reference signal resource configuration, then the terminal determines to use two TRPs for transmission. If the terminal reports the measurement result obtained based on the third reference signal resource configuration, then the terminal determines to use three TRPs for transmission. If the terminal reports the measurement result obtained based on the fourth reference signal resource configuration, the terminal determines to use four TRPs for transmission. In some embodiments, if the terminal determines to use three TRPs for transmission, the terminal also needs to report an identifier corresponding to the third reference signal resource configuration, because the transmission based on three TRPs also corresponds to multiple third reference signal resource configurations. That is, the combination of the three TRPs (such as TRP #1, TRP #2, and TRP #3) corresponding to the third reference signal resource configuration corresponding to the identifier is determined.

In some embodiments, the channel state information includes at least one of the following:
(1) at least one PMI (Precoding Matrix Indication)

In some embodiments, one PMI is a joint PMI for multiple TRPs. In some embodiments, each PMI in the at least one PMI is an independent PMI for each TRP.
(2) at least one CQI (Channel Quality Indication)

In some embodiments, one CQI is a joint CQI for multiple TRPs. In some embodiments, each CQI in the at least one CQI is an independent CQI for each TRP.
(3) at least one LI (Layer Indication)

In some embodiments, one LI is a joint LI for multiple TRPs. In some embodiments, each LI in the at least one LI is an independent LI for each TRP.
(4) at least one RI (Rank Indication)

In some embodiments, one RI is a joint RI for multiple TRPs. In some embodiments, each RI in the at least one RI is an independent RI for each TRP.

In step 1202, the network device receives the channel state information sent by the terminal. The channel state information is obtained by the terminal through the measurement based on the reference signal resource configuration, and is sent by the terminal based on the type of the reference signal resource configuration.

In some embodiments, the channel state information includes a measurement result obtained through the measurement based on one determined type of reference signal resource configuration out of at least one type of reference signal resource configuration, and the measurement result includes a report configuration identifier corresponding to a determined CMR resource set included in the reference signal resource configuration determined.

According to embodiments of the present disclosure, the terminal determines the reference signal resource configuration based on the reference signal resource configuration configured by the network device, so as to perform the measurement based on the CMR resource sets included in the reference signal resource configuration determined, and to obtain the channel state information through the measurement. The present disclosure expands the resource configuration method for determining the CMR resource set, further expands the channel measurement method, and improves the transmission efficiency.

Based on embodiments shown in FIG. 4, the terminal can determine different types of reference signal resource configurations based on the reference signal resource configuration by the network device. FIG. 13 shows a flowchart of an information transmission method according to embodiments of the present disclosure. As shown in FIG. 13, the method includes following steps.

In step 1301, the terminal sends, based on a type of a reference signal resource configuration, channel state information to the network device. The channel state information includes a measurement result obtained through a measurement based on each type of reference signal resource configuration out of at least one type of reference signal resource configuration, and the measurement result includes a report configuration identifier corresponding to a determined CMR resource set included in the reference signal resource configuration.

In some embodiments of the present disclosure, for all types of reference signal resource configurations, one group of channel state information corresponding to each type is sent separately. In some embodiments, all types of reference signal resource configurations include at least one of the first reference signal resource configuration, the second reference signal resource configuration, the third reference signal resource configuration, or the fourth reference signal resource configuration. In some embodiments, if the terminal is configured with multiple types of reference signal resource configurations (for example, four types of reference signal resource configurations), the channel state information reported by the terminal includes the measurement results obtained through the measurements based on each type of reference signal resource configuration. In some embodiments, the terminal reports measurement result 1 obtained based on the first reference signal resource configuration, measurement result 2 obtained based on the second reference signal resource configuration, measurement result 3 obtained based on the third reference signal resource configuration, and measurement result 4 obtained based on the fourth reference signal resource configuration. It can also be understood that the terminal does not determine the quantity of the TRPs, but instead determines one combination of TRPs for each quantity and sent the channel measurement result corresponding to this combination to the network device. For each quantity or for each type, since the terminal is configured with multiple reference signal resource configurations, the terminal needs to report, for each quantity, an identifier corresponding to the reference signal resource configuration, which means that the combination of TRPs corresponding to the identifier is determined. For example, for the first reference signal resource configuration, an identifier of the first reference signal resource configuration #1 is reported, which means that TRP #1 is correspondingly used for transmission. For example, for the second reference signal resource configuration, an identifier of the second reference signal resource configuration #2 is reported, which means that TRP #1 and TRP #3 are correspondingly used for transmission. For example, for the third reference signal resource configuration, an identifier of the third reference signal resource configuration #1 is reported, which means that TRP #1, TRP #2, and TRP #3 are correspondingly used for transmission. For example, for the fourth reference signal resource configuration, an identifier of the fourth reference signal resource configuration #1 is reported, which means that TRP #1, TRP #2, TRP #3, and TRP #4 are correspondingly used for transmission.

In some embodiments, the channel state information includes at least one of the following:
(1) at least one PMI (Precoding Matrix Indication)

In some embodiments, one PMI is a joint PMI for multiple TRPs. In some embodiments, each PMI in the at least one PMI is an independent PMI for each TRP.
(2) at least one CQI (Channel Quality Indication)

In some embodiments, one CQI is a joint CQI for multiple TRPs. In some embodiments, each CQI in the at least one CQI is an independent CQI for each TRP.
(3) at least one LI (Layer Indication)

In some embodiments, one LI is a joint LI for multiple TRPs. In some embodiments, each LI in the at least one LI is an independent LI for each TRP.
(4) at least one RI (Rank Indication)

In some embodiments, one RI is a joint RI for multiple TRPs. In some embodiments, each RI in the at least one RI is an independent RI for each TRP.

In step 1302, the network device receives the channel state information sent by the terminal. The channel state information is sent by the terminal based on each type of reference signal resource configuration, and is obtained by the terminal through a measurement based on each type of reference signal resource configuration.

The channel state information includes a measurement result obtained through a measurement based on each type of reference signal resource configuration out of at least one type of reference signal resource configuration, and the measurement result includes a report configuration identifier corresponding to a determined CMR resource set included in the reference signal resource configuration.

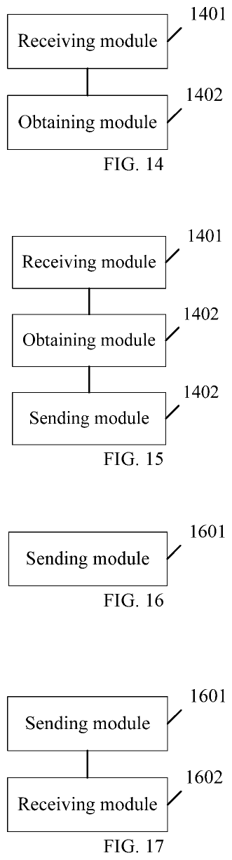

FIG. 14 shows a block diagram of an information configuration apparatus according to embodiments of the present disclosure. As shown in FIG. 14, the apparatus includes a receiving module 1401 and an obtaining module 1402.

The receiving module 1401 is configured to receive first configuration information sent by a network device. The first configuration information includes a reference signal resource configuration, the reference signal resource configuration includes N CMR resource sets, and the CMR resource sets include at least one CMR resource, where N is a positive integer greater than0.

The obtaining module 1402 is configured to obtain channel state information by performing a measurement based on the reference signal resource configuration.

In some embodiments, the obtaining module 1402 is configured to determine at least one first reference signal resource configuration based on the first configuration information, and obtain the channel state information by performing the measurement based on the at least one first reference signal resource configuration. The first reference signal resource configuration includes one CMR resource set.

In some embodiments, the receiving module 1401 is configured to receive second configuration information sent by the network device, which is configured to indicate that the second reference signal resource configuration and the first reference signal resource configuration share the CMR resource set.

In some embodiments, CMR resource sets included in any two first reference signal resource configurations correspond to the same CMR resource.

In some embodiments, the any two first reference signal resource configurations include different IMRs.

In some embodiments, there is at least one different CMR resource between CMR resource sets included in any two first reference signal resource configurations.

In some embodiments, the any two first reference signal resource configurations include different IMRs, or the any two first reference signal resource configurations include the same IMR.

In some embodiments, the obtaining module 1402 is further configured to determine at least one second reference signal resource configuration based on the first configuration information, and obtain the channel state information by performing the measurement based on the at least one second reference signal resource configuration. The second reference signal resource configuration includes two CMR resource sets. In some embodiments, the obtaining module 1402 is further configured to determine at least two first reference signal resource configurations based on the first configuration information, determine the at least one second reference signal resource configuration based on the at least two first reference signal resource configurations, and obtain the channel state information by performing the measurement based on the at least one second reference signal resource configuration. Each first reference signal resource configuration includes one CMR resource set, the second reference signal resource configuration includes two CMR resource sets, and each CMR resource set is the one CMR resource set included in the first reference signal resource configuration.

In some embodiments, the receiving module 1401 is further configured to receive third configuration information sent by the network device, the third configuration information being configured to indicate that the third reference signal resource configuration and the first reference signal resource configuration share the CMR resource set; and/or to receive fourth configuration information sent by the network device, the fourth configuration information being configured to indicate that the third reference signal resource configuration and the second reference signal resource configuration share the CMR resource set.

In some embodiments, there is at least one different CMR resource between CMR resource sets included in any two third reference signal resource configurations.

In some embodiments, the any two third reference signal resource configurations include different IMRs, or the any two third reference signal resource configurations include the same IMR.

In some embodiments, CMR resource sets included in any two third reference signal resource configurations correspond to the same CMR resource.

In some embodiments, the any two third reference signal resource configurations include different IMRs.

In some embodiments, the obtaining module 1402 is further configured to determine at least one third reference signal resource configuration based on the first configuration information, and obtain the channel state information by performing the measurement based on the at least one third reference signal resource configuration. The third reference signal resource configuration includes three CMR resource sets. In some embodiments, the obtaining module 1402 is further configured to determine at least one first reference signal resource configuration and/or at least one second reference signal resource configuration based on the first configuration information, determine the at least one third reference signal resource configuration based on the at least one first reference signal resource configuration and/or the at least one second reference signal resource configuration, and obtain the channel state information by performing the measurement based on the at least one third reference signal resource configuration. Each first reference signal resource configuration includes one CMR resource set, each second reference signal resource configuration includes two CMR resource sets, the third reference signal resource configuration includes three CMR resource sets, and each CMR resource set is the one CMR resource set included in the first reference signal resource configuration, or one CMR resource set of the two CMR resource sets included in the second reference signal resource configuration.

In some embodiments, the receiving module 1401 is further configured to receive third configuration information sent by the network device, the third configuration information being configured to indicate that the third reference signal resource configuration and the first reference signal resource configuration share the CMR resource set; and/or to receive fourth configuration information sent by the network device, the fourth configuration information being configured to indicate that the third reference signal resource configuration and the second reference signal resource configuration share the CMR resource set.

In some embodiments, there is at least one different CMR resource between CMR resource sets included in any two third reference signal resource configurations.

In some embodiments, the any two third reference signal resource configurations include different IMRs, or the any two third reference signal resource configurations include the same IMR.

In some embodiments, CMR resource sets included in any two third reference signal resource configurations correspond to the same CMR resource.

In some embodiments, the any two third reference signal resource configurations include different IMRs.

In some embodiments, the obtaining module 1402 is further configured to determine at least one fourth reference signal resource configuration based on the first configuration information, and obtain the channel state information by performing the measurement based on the at least one fourth reference signal resource configuration. The fourth reference signal resource configuration includes four CMR resource sets. In some embodiments, the obtaining module 1402 is further configured to determine at least one of at least one first reference signal resource configuration, at least one second reference signal resource configuration, or at least one third reference signal resource configuration based on the first configuration information, determine the at least one fourth reference signal resource configuration based on at least one of the at least one first reference signal resource configuration, the at least one second reference signal resource configuration, or the at least one third reference signal resource configuration, and obtain the channel state information by performing the measurement based on the at least one fourth reference signal resource configuration. Each first reference signal resource configuration includes one CMR resource set, each second reference signal resource configuration includes two CMR resource sets, each third reference signal resource configuration includes three CMR resource sets, the fourth reference signal resource configuration includes four CMR resource sets, and each CMR resource set is the one CMR resource set included in the first reference signal resource configuration, or one CMR resource set of the two CMR resource sets included in the second reference signal resource configuration, or one CMR resource set of the three CMR resource sets included in the third reference signal resource configuration.

In some embodiments, the receiving module 1401 is further configured to receive fifth configuration information sent by the network device, the fifth configuration information being configured to indicate that the fourth reference signal resource configuration and the first reference signal resource configuration share the CMR resource set; and/or to receive sixth configuration information sent by the network device, the sixth configuration information being configured to indicate that the fourth reference signal resource configuration and the second reference signal resource configuration share the CMR resource set; and/or to receive seventh configuration information sent by the network device, the seventh configuration information being configured to indicate that the fourth reference signal resource configuration and the third reference signal resource configuration share the CMR resource set.

In some embodiments, there is at least one different CMR resource between CMR resource sets included in any two fourth reference signal resource configurations.

In some embodiments, the any two fourth reference signal resource configurations include different IMRs, or the any two fourth reference signal resource configurations include the same IMR.

In some embodiments, CMR resource sets included in any two fourth reference signal resource configurations correspond to the same CMR resource.

In some embodiments, the any two fourth reference signal resource configurations include different IMRs.

In some embodiments, each CMR resource set corresponds to a TRP.

In some embodiments, as shown in FIG. 15, the apparatus further includes a sending module 1403.

The sending module 1403 is configured to send, based on a type of the reference signal resource configuration, the channel state information to the network device. The channel state information includes a measurement result obtained through the measurement based on one determined type of reference signal resource configuration out of at least one type of reference signal resource configuration, and the measurement result includes a report configuration identifier corresponding to a determined CMR resource set included in the reference signal resource configuration determined.

In some embodiments, as shown in FIG. 15, the apparatus further includes a sending module 1403.

The sending module 1403 is configured to send, based on a type of the reference signal resource configuration, the channel state information to the network device. The channel state information includes a measurement result obtained through the measurement based on each type of reference signal resource configuration out of at least one type of reference signal resource configuration, and the measurement result includes a report configuration identifier corresponding to a determined CMR resource set included in the reference signal resource configuration.

In some embodiments, the channel state information includes at least one of the following: at least one PMI, at least one CQI, at least one LI, or at least one RI.

It should be noted that the apparatus provided in the above embodiments only provides examples of the division of each functional module when realizing functions of the apparatus. In practical applications, the above functions can be assigned to different functional modules according to needs. That is, the internal structure of the apparatus can be divided into different functional modules to complete all or part of the functions described above. In addition, the apparatus and method embodiments provided in the above are based on the same concept, and the specific implementation process is detailed in the method embodiments, which will not be repeated here.

FIG. 16 shows a block diagram of an information configuration apparatus according to embodiments of the present disclosure. As shown in FIG. 16, the apparatus includes a sending module 1601.

The sending module 1601 is configured to send first configuration information to a terminal. The first configuration information includes a reference signal resource configuration, the reference signal resource configuration includes N CMR resource sets, and the CMR resource sets include at least one CMR resource, where N is a positive integer greater than 0.

In some embodiments, the first configuration information is configured to indicate at least one first reference signal resource configuration, which includes one CMR resource set.

In some embodiments, CMR resource sets included in any two first reference signal resource configurations correspond to the same CMR resource.

In some embodiments, the any two first reference signal resource configurations include different IMRs.

In some embodiments, there is at least one different CMR resource between CMR resource sets included in any two first reference signal resource configurations.

In some embodiments, the any two first reference signal resource configurations include different IMRs, or the any two first reference signal resource configurations include the same IMR.

In some embodiments, the first configuration information is configured to indicate at least one second reference signal resource configuration, which includes two CMR resource sets.

In some embodiments, the first configuration information is configured to indicate at least two first reference signal resource configurations. Each first reference signal resource configuration includes one CMR resource set, the at least two first reference signal resource configurations are configured for the terminal to determine the at least one second reference signal resource configuration, the second reference signal resource configuration includes two CMR resource sets, and each CMR resource set in the second reference signal resource configuration is the one CMR resource set included in the first reference signal resource configuration.

In some embodiments, the sending module 1601 is configured to send second configuration information to the terminal, the second configuration information being configured to indicate that the second reference signal resource configuration and the first reference signal resource configuration share the CMR resource set.

In some embodiments, there is at least one different CMR resource between CMR resource sets included in any two second reference signal resource configurations.

In some embodiments, the any two second reference signal resource configurations include different IMRs, or the any two second reference signal resource configurations include the same IMR.

In some embodiments, CMR resource sets included in any two second reference signal resource configurations correspond to the same CMR resource.

In some embodiments, the any two second reference signal resource configurations include different IMRs.

In some embodiments, the first configuration information is configured to indicate at least one third reference signal resource configuration, which includes three CMR resource sets.

In some embodiments, the first configuration information is configured to indicate at least one first reference signal resource configuration and/or at least one second reference signal resource configuration. Each first reference signal resource configuration includes one CMR resource set, each second reference signal resource configuration includes two CMR resource sets, the at least one first reference signal resource configuration and/or the at least one second reference signal resource configuration is configured for the terminal to determine the at least one third reference signal resource configuration, the third reference signal resource configuration includes three CMR resource sets, and each CMR resource set is the one CMR resource set included in the first reference signal resource configuration, or one CMR resource set of the two CMR resource sets included in the second reference signal resource configuration.

In some embodiments, the sending module 1601 is further configured to send third configuration information to the terminal, the third configuration information being configured to indicate that the third reference signal resource configuration and the first reference signal resource configuration share the CMR resource set; and/or to send fourth configuration information to the terminal, the fourth configuration information being configured to indicate that the third reference signal resource configuration and the second reference signal resource configuration share the CMR resource set.

In some embodiments, there is at least one different CMR resource between CMR resource sets included in any two third reference signal resource configurations.

In some embodiments, the any two third reference signal resource configurations include different IMRs, or the any two third reference signal resource configurations include the same IMR.

In some embodiments, CMR resource sets included in any two third reference signal resource configurations correspond to the same CMR resource.

In some embodiments, the any two third reference signal resource configurations include different IMRs.

In some embodiments, the first configuration information is configured to indicate at least one fourth reference signal resource configuration, which includes four CMR resource sets.

In some embodiments, the first configuration information is configured to indicate at least one of at least one first reference signal resource configuration, at least one second reference signal resource configuration, or at least one third reference signal resource configuration. Each first reference signal resource configuration includes one CMR resource set, each second reference signal resource configuration includes two CMR resource sets, each third reference signal resource configuration includes three CMR resource sets, at least one of the at least one first reference signal resource configuration, the at least one second reference signal resource configuration, or the at least one third reference signal resource configuration is configured for the terminal to determine the at least one fourth reference signal resource configuration, the fourth reference signal resource configuration includes four CMR resource sets, and each CMR resource set is the one CMR resource set included in the first reference signal resource configuration, or one CMR resource set of the two CMR resource sets included in the second reference signal resource configuration, or one CMR resource set of the three CMR resource sets included in the third reference signal resource configuration.

In one embodiment, the sending module 1601 is further configured to send fifth configuration information to the terminal, the fifth configuration information being configured to indicate that the fourth reference signal resource configuration and the first reference signal resource configuration share the CMR resource set; and/or to send sixth configuration information to the terminal, the sixth configuration information being configured to indicate that the fourth reference signal resource configuration and the second reference signal resource configuration share the CMR resource set; and/or to send seventh configuration information to the terminal, the seventh configuration information being configured to indicate that the fourth reference signal resource configuration and the third reference signal resource configuration share the CMR resource set.

In some embodiments, there is at least one different CMR resource between CMR resource sets included in any two fourth reference signal resource configurations.

In some embodiments, the any two fourth reference signal resource configurations include different IMRs, or the any two fourth reference signal resource configurations include the same IMR.

In some embodiments, CMR resource sets included in any two fourth reference signal resource configurations correspond to the same CMR resource.

In some embodiments, the any two fourth reference signal resource configurations include different IMRs.

In some embodiments, each CMR resource set corresponds to a TRP.

In some embodiments, as shown in FIG. 17, the apparatus further includes a receiving module 1602.

The receiving module 1602 is configured to receive channel state information sent by the terminal. The channel state information is obtained through a measurement by the terminal based on the reference signal resource configuration and is sent by the terminal based on a type of the reference signal resource configuration. The channel state information includes a measurement result obtained through the measurement based on one determined type of reference signal resource configuration out of at least one type of reference signal resource configuration, and the measurement result includes a report configuration identifier corresponding to a determined CMR resource set included in the reference signal resource configuration determined.

In some embodiments, as shown in FIG. 17, the apparatus further includes a receiving module 1602.

The receiving module 1602 is configured to receive channel state information sent by the terminal. The channel state information is obtained through a measurement by the terminal based on the reference signal resource configuration and is sent by the terminal based on a type of the reference signal resource configuration. The channel state information includes a measurement result obtained through the measurement based on each type of reference signal resource configuration out of at least one type of reference signal resource configuration, and the measurement result includes a report configuration identifier corresponding to a determined CMR resource set included in the reference signal resource configuration.

In some embodiments, the channel state information includes at least one of the following: at least one PMI, at least one CQI, at least one LI, or at least one RI.

It should be noted that the apparatus provided in the above embodiments only provides examples of the division of each functional module when realizing functions of the apparatus. In practical applications, the above functions can be assigned to different functional modules according to needs. That is, the internal structure of the apparatus can be divided into different functional modules to complete all or part of the functions described above. In addition, the apparatus and method embodiments provided in the above are based on the same concept, and the specific implementation process is detailed in the method embodiments, which will not be repeated here.

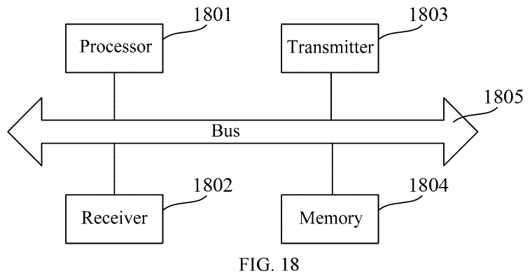

FIG. 18 shows a schematic diagram of a structure of a communication device according to embodiments of the present disclosure. The communication device includes a processor 1801, a receiver 1802, a transmitter 1803, a memory 1804, and a bus 1805.

The processor 1801 includes one or more processing cores, which execute various functional applications and information processing by running software programs and modules.

The receiver 1802 and the transmitter 1803 can be embodied as a communication component, which can be a communication chip.

The memory 1804 is connected to the processor 1801 via the bus 1805.

The memory 1804 can be configured to store at least one program code, and the processor 1801 is configured to execute the at least one program code to implement the various steps in the above method embodiments.

In addition, the communication device can be a terminal or an access network device. The memory 1804 can be embodied by any type of volatile or non-volatile storage device, or a combination thereof. Volatile or non-volatile storage devices include but are not limited to: magnetic disks or optical discs, electrically erasable programmable read-only memory (EEPROM), erasable programmable read-only memory (EPROM), static random-access memory (SRAM), read-only memory (ROM), magnetic memory, flash memory, and programmable read-only memory (PROM).

In some embodiments, a computer-readable storage medium is also provided, which stores executable program codes, and the executable program codes can be loaded and executed by a processor to implement the information configuration methods executed by a communication device provided in the above method embodiments.

In some embodiments, a chip is provided, which includes programmable logic circuits and/or program instructions, for implementing the information configuration methods provided in the above method embodiments when the chip runs on a terminal or a network device.

In some embodiments, a computer program product is provided for implementing the information configuration methods provided in the above method embodiments when the computer program product is executed by a processor of a terminal or a network device.

Those of ordinary skill in the art can understand that all or part of the steps to implement the above embodiments can be completed through hardware, or by instructing relevant hardware through programs. The programs can be stored in a computer-readable storage medium, which can be read-only memory, disk, or optical disc, etc.

The above description is only embodiments of present disclosure and is not intended to limit the present disclosure. Any modifications, equivalent substitutions, improvements, etc. made within the spirit and principle of the present disclosure shall be included within the protection scope of the present disclosure.

1. An information configuration method, performed by a terminal, the method comprising:
receiving first configuration information sent by a network device, wherein the first configuration information comprises a reference signal resource configuration, the reference signal resource configuration comprises N channel measurement resource (CMR) resource sets, and each CMR resource set comprises at least one CMR resource, where N is a positive integer greater than 0; and
obtaining channel state information by performing a measurement based on the reference signal resource configuration.

2. The method according to claim 1, wherein obtaining the channel state information by performing the measurement based on the reference signal resource configuration, comprises:
determining at least one first reference signal resource configuration based on the first configuration information, wherein each first reference signal resource configuration comprises one CMR resource set; and
obtaining the channel state information by performing the measurement based on the at least one first reference signal resource configuration.

3. The method according to claim 2, wherein any two of the at least one first reference signal resource configuration satisfy at least one of:
the CMR resource sets comprised in the any two first reference signal resource configurations correspond to a same CMR resource;
there is at least one different CMR resource between the CMR resource sets comprised in the any two first reference signal resource configurations;
the any two first reference signal resource configurations comprise different interference measurement resources (IMRs); or
the any two first reference signal resource configurations comprise a same IMR.

4-6. (canceled)

7. The method according to claim 1, wherein obtaining the channel state information by performing the measurement based on the reference signal resource configuration, comprises:
determining at least one second reference signal resource configuration based on the first configuration information, wherein each second reference signal resource configuration comprises two CMR resource sets, and
obtaining the channel state information by performing the measurement based on the at least one second reference signal resource configuration; or
determining at least two first reference signal resource configurations based on the first configuration information, wherein each first reference signal resource configuration comprises one CMR resource set,
determining the at least one second reference signal resource configuration based on the at least two first reference signal resource configurations, wherein each second reference signal resource configuration comprises two CMR resource sets, and each CMR resource set comprised in the respective second reference signal resource configuration is the one CMR resource set comprised in the first reference signal resource configuration, and
obtaining the channel state information by performing the measurement based on the at least one second reference signal resource configuration.

8. The method according to claim 7, wherein determining the at least one second reference signal resource configuration based on the at least two first reference signal resource configurations, comprises:
receiving second configuration information sent by the network device, wherein the second configuration information is configured to indicate that the at least one second reference signal resource configuration and the at least one first reference signal resource configuration share the CMR resource set.

9. The method according to claim 7, wherein any two of the at least one second reference signal resource configuration satisfy at least one of:
there is at least one different CMR resource between the CMR resource sets comprised in the any two second reference signal resource configurations;
the CMR resource sets comprised in the any two second reference signal resource configurations correspond to a same CMR resource;
the any two second reference signal resource configurations comprise a same IMR; or
the any two second reference signal resource configurations comprise different IMRs.

10-12. (canceled)

13. The method according to claim 1, wherein obtaining the channel state information by performing the measurement based on the reference signal resource configuration, comprises:
determining at least one third reference signal resource configuration based on the first configuration information, wherein each third reference signal resource configuration comprises three CMR resource sets, and
obtaining the channel state information by performing the measurement based on the at least one third reference signal resource configuration; or
determining at least one of at least one first reference signal resource configuration or at least one second reference signal resource configuration based on the first configuration information, wherein each first reference signal resource configuration comprises one CMR resource set, and each second reference signal resource configuration comprises two CMR resource sets,
determining the at least one third reference signal resource configuration based on at least one of the at least one first reference signal resource configuration or the at least one second reference signal resource configuration, wherein each third reference signal resource configuration comprises three CMR resource sets, and each CMR resource set comprised in the respective third reference signal resource configuration is the one CMR resource set comprised in the first reference signal resource configuration, or one CMR resource set of the two CMR resource sets comprised in the second reference signal resource configuration, and
obtaining the channel state information by performing the measurement based on the at least one third reference signal resource configuration.

14. The method according to claim 13, wherein determining the at least one third reference signal resource configuration based on at least one of the at least one first reference signal resource configuration or the at least one second reference signal resource configuration, comprises at least one of:
receiving third configuration information sent by the network device, wherein the third configuration information is configured to indicate that the at least one third reference signal resource configuration and the at least one first reference signal resource configuration share the CMR resource set; or
receiving fourth configuration information sent by the network device, wherein the fourth configuration information is configured to indicate that the at least one third reference signal resource configuration and the at least one second reference signal resource configuration share the CMR resource set.

15. The method according to claim 13, wherein any two of the at least one third reference signal resource configuration satisfy at least one of:
there is at least one different CMR resource between the CMR resource sets comprised in the any two third reference signal resource configurations;
the CMR resource sets comprised in the any two third reference signal resource configurations correspond to a same CMR resource;
the any two third reference signal resource configurations comprise a same IMR; or
the any two third reference signal resource configurations comprise different IMRs.

16-18. (canceled)

19. The method according to claim 1, wherein obtaining the channel state information by performing the measurement based on the reference signal resource configuration, comprises:
determining at least one fourth reference signal resource configuration based on the first configuration information, wherein each fourth reference signal resource configuration comprises four CMR resource sets, and
obtaining the channel state information by performing the measurement based on the at least one fourth reference signal resource configuration; or
determining at least one of at least one first reference signal resource configuration, at least one second reference signal resource configuration, or at least one third reference signal resource configuration based on the first configuration information, wherein each first reference signal resource configuration comprises one CMR resource set, each second reference signal resource configuration comprises two CMR resource sets, and each third reference signal resource configuration comprises three CMR resource sets,
determining the at least one fourth reference signal resource configuration based on at least one of the at least one first reference signal resource configuration, the at least one second reference signal resource configuration, or the at least one third reference signal resource configuration, wherein each fourth reference signal resource configuration comprises four CMR resource sets, and each CMR resource set comprised in the respective fourth reference signal resource configuration is the one CMR resource set comprised in the first reference signal resource configuration, or one CMR resource set of the two CMR resource sets comprised in the second reference signal resource configuration, or one CMR resource set of the three CMR resource sets comprised in the third reference signal resource configuration; and
obtaining the channel state information by performing the measurement based on the at least one fourth reference signal resource configuration.

20. The method according to claim 19, wherein determining the at least one fourth reference signal resource configuration based on at least one of the at least one first reference signal resource configuration, the at least one second reference signal resource configuration, or the at least one third reference signal resource configuration, comprises at least one of:
receiving fifth configuration information sent by the network device, wherein the fifth configuration information is configured to indicate that the at least one fourth reference signal resource configuration and the at least one first reference signal resource configuration share the CMR resource set;
receiving sixth configuration information sent by the network device, wherein the sixth configuration information is configured to indicate that the at least one fourth reference signal resource configuration and the at least one second reference signal resource configuration share the CMR resource set; or
receiving seventh configuration information sent by the network device, wherein the seventh configuration information is configured to indicate that the at least one fourth reference signal resource configuration and the at least one third reference signal resource configuration share the CMR resource set.

21. The method according to claim 19, wherein any two of the at least one fourth reference signal resource configuration satisfy at least one of:
there is at least one different CMR resource between the CMR resource sets comprised in the any two fourth reference signal resource configurations;
the CMR resource sets comprised in the any two fourth reference signal resource configurations correspond to a same CMR resource;
the any two fourth reference signal resource configurations comprise a same IMR; or
the any two fourth reference signal resource configurations comprise different IMRs.

22-24. (canceled)

25. The method according to claim 1, wherein each CMR resource set corresponds to one transmission reception point (TRP).

26. The method according to claim 1, further comprising:
sending, based on a type of the reference signal resource configuration, the channel state information to the network device, wherein the channel state information comprises a measurement result obtained through the measurement based on one determined type of reference signal resource configuration out of at least one type of reference signal resource configuration, and the measurement result comprises a report configuration identifier corresponding to a determined CMR resource set comprised in the reference signal resource configuration determined.

27. The method according to claim 1, further comprising:
sending, based on a type of the reference signal resource configuration, the channel state information to the network device, wherein the channel state information comprises a measurement result obtained through the measurement based on each type of reference signal resource configuration out of at least one type of reference signal resource configuration, and the measurement result comprises a report configuration identifier corresponding to a determined CMR resource set comprised in the reference signal resource configuration.

28. The method according to claim 1, wherein the channel state information comprises at least one of:
at least one Precoding Matrix Indication (PMI);
at least one Channel Quality Indication (CQI);
at least one Layer Indication (LI); or
at least one Rank Indication (RI).

29. An information configuration method, performed by a network device, the method comprising:
sending first configuration information to a terminal, wherein the first configuration information comprises a reference signal resource configuration, the reference signal resource configuration comprises N channel measurement resource (CMR) resource sets, and each CMR resource set comprises at least one CMR resource, where N is a positive integer greater than 0.

30-55. (canceled)

56. The method according to claim 29, further comprising:
receiving channel state information sent by the terminal, wherein the channel state information comprises at least one of:
at least one Precoding Matrix Indication (PMI);
at least one Channel Quality Indication (CQI);
at least one Layer Indication (LI); or
at least one Rank Indication (RI).

57-58. (canceled)

59. A terminal, comprising:
a processor;
a memory for storing executable instructions; and
a transceiver coupled to the processor,
wherein the processor is configured to load and execute the executable instructions to implement the information configuration method according to claim 1.

60. A network device, comprising:
a processor;
a memory for storing executable instructions; and
a transceiver coupled to the processor,
wherein the processor is configured to load and execute the executable instructions to implement the information configuration method according to claim 29.

61-62. (canceled)
